(19) United States
(12) Patent Application Publication
(10) Pub. No.: US 2007/0192697 A1
(43) Pub. Date: Aug. 16, 2007

(54) Information process apparatus and method, record medium, and program

(76) Inventors: Takayoshi Kawamura, Kanagawa (JP); Hideki Ando, Kanagawa (JP); Hideaki Mita, Hyogo (JP); Keiichi Teranishi, Osaka (JP); Tatsushi Bannai, Osaka (JP)

Correspondence Address: William S Frommer;Frommer Lawrence & Haug, 745 Fifth Avenue, New York, NY, 10151, US

(21) Appl. No.: 10/560,154

(22) PCT Filed: Jun. 9, 2004
(86) PCT No.: PCT/JP04/08416

§ 371 Date: Jan. 12, 2007

(30) Foreign Application Priority Data
Jun. 11, 2003 (JP) 2003-166312

(51) Int. Cl. G06F 3/00; H04L 9/32

(52) U.S. Cl. 715/716; 726/2

(57) ABSTRACT

To allow the determination of whether data can be reproduced to be easily performed. When a plurality of clips generated by a photographing process are connected as an edit, an edit list management section 15 identifies encoding systems of a plurality of clips (video files) to be connected and writes the identified encoding systems to an edit list file that manages an edited result. An optical disc 30 on which a clip, an edit list file, and so forth have been recorded is loaded into another reproduction apparatus. When a command that causes an edited result recorded on the optical disc 30 to be reproduced is input to the other reproduction apparatus, the reproduction apparatus reads encoding systems written in the edit list file and determines whether the encoding systems are systems for which that the reproduction apparatus can decode data. In this manner, the reproduction apparatus determines whether it can reproduce the edited result. The present invention can be applied to an edit apparatus that edits for example pictures and so forth.

### TECHNICAL FIELD

The present invention relates to an information process apparatus and method, a record medium, and a program, in particular, to those that allow the determination of whether data can be reproduced to be easily performed.

### BACKGROUND ART

In recent years, as the prices of record mediums such as CD-RW (Compact Disk-ReWritable) and DVD-RW (Digital Versatile Disc-ReWritable) on and from which data can be repeatedly written and erased have been decreased, they are being widespread.

Such a disc-shaped record-medium can be loaded into a photographing apparatus. Moving picture data and audio data (hereinafter, they may be together referred to as AV data) obtained by a photographing process can be recorded on the record-medium. In addition, desired parts of a plurality of pieces of AV data recorded on a record medium by a photographing process performed a plurality of number of times can be connected as an edit process.

However, when a plurality of pieces of AV data recorded on a record medium by a photographing process performed a plurality of number of times have been encoded according to different encoding systems, a reproduction apparatus that reproduces the edited data needs to execute different decode processes according to different encoding systems for all pieces of encoded data that have been connected.

Now, it is assumed that three pieces of AV data have been generated by a photographing process performed three times. The three pieces of AV data are referred to as AV data A, AV data B, and AV data C. In addition, it is assumed that AV data A, AV data B, and AV data C have been encoded according to different encoding systems. In addition, it is assumed that these three pieces of AV data have been connected as an edit process. In this case, the reproduction apparatus that reproduces the edited, result needs to perform different decode processes according to the different encoding systems for AV data A, AV data B, and AV data C. In other words, if the reproduction apparatus does not have a decoder according to the encoding system for AV data C, the reproduction apparatus cannot reproduce the edited result.

Thus, the reproduction apparatus needs to determine whether it can reproduce the edited result (it has all decoders that decode AV data A, AV data B, and AV data C) before the apparatus reproduces the edited result.

However, to identify encoding systems of a plurality of pieces of AV data that compose the edited result, it takes a long time to detect encoding systems for individual pieces of AV data. Thus, it cannot be quickly determined whether the edited result can be reproduced.

### DISCLOSURE OF THE INVENTION

The present invention is made from this point of view and an object thereof is to allow the determination of whether data can be reproduced to be more easily performed than before.

A first information process apparatus according to the present invention comprises identification means for identifying encoding systems for a plurality of pieces of data that have been connected and successively reproduced as an edit process; and generation means for generating one management information file that contains encoding system information representing the encoding systems identified by the identification means and that manages an edited result of the plurality of pieces of data.

A first information process method according to the present invention comprises the steps of identifying encoding systems for a plurality of pieces of data that have been connected and successively reproduced as an edit process; and generating, one management information file that contains encoding system information representing the encoding systems identified at the identification step and that manages an edited result of the plurality of pieces of data.

A program of a first record medium according to the present invention comprises the steps of identifying encoding systems for a plurality of pieces of data that have been connected and successively reproduced as an edit process; and generating one management information file that contains encoding system information representing the encoding systems identified at the identification step and that manages an edited result of the plurality of pieces of data.

A first program according to the present invention causing a computer to execute a process, comprising the steps of identifying encoding systems for a plurality of pieces of data that have been connected and successively reproduced as an edit process; and generating one management information file that contains encoding system information representing the encoding systems identified at the identification step and that manages an edited result of the plurality of pieces of data.

A second information process apparatus according to the present invention comprises determination means for determining whether the plurality of pieces of data can be reproduced according to encoding system information that is recorded in one information file and that represents encoding systems for the plurality of pieces of data, the information file managing an edited result of the plurality of pieces of data.

A second information process method according to the present invention comprises the step of determining whether the plurality of pieces of data can be reproduced according to encoding system information that is recorded in one information file and that represents encoding systems for the plurality of pieces of data, the information file managing an edited result of the plurality of pieces of data.

A program of a second record medium according to the present invention comprises the step of determining whether the plurality of pieces of data can be reproduced according to encoding system information that is recorded in one information file and that represents encoding systems for the plurality of pieces of data, the information file managing an edited result of the plurality of pieces of data.

A second program according to the present invention comprises the step of determining whether the plurality of pieces of data can be reproduced according to encoding system information that is recorded in one information file and that represents encoding systems for the plurality of pieces of data, the information file managing an edited result of the plurality of pieces of data.

According to the first information process apparatus and method, record medium, and program, encoding systems of the present invention are identified for a plurality of pieces of data that have been connected and successively reproduced as an edit process one management information file is generated that contains encoding system information representing the encoding systems identified at the identification step and that manages an edited result of the plurality of pieces of data.

According to the second information process apparatus and method, record medium, and program of the present invention, it is determined whether the plurality of pieces of data can be reproduced according to encoding system information that is recorded in one information file and that represents encoding systems for the plurality of pieces of data, the information file managing an edited result of the plurality of pieces of data.

The present invention can be applied to a photographing device that photographs pictures and an editing device that edits pictures.

### BRIEF DESCRIPTION OF DRAWINGS

FIG. 1 is a block diagram showing an example, of the structure of a record and reproduction apparatus according to the present invention;

FIG. 2 is a block diagram showing an example of the internal structure of an edit list management section shown in FIG. 1;

FIG. 3 is a block diagram showing an example of the structure of the record and reproduction apparatus according to the present invention;

FIG. 4 is a block diagram showing an example of the internal structure of a reproduction control section shown in FIG. 3;

FIG. 5 is a schematic diagram showing an example of the structure of directories that manage data recorded on an optical disc shown in FIG. 1;

FIG. 6 is a schematic diagram showing an example of the detailed structure of the directories shown in FIG. 5;

FIG. 7 is a list showing an example of a script of an index file;

FIG. 8 is a list showing an example of the script of the index file as a part preceded by FIG. 7;

FIG. 9 is a list showing an example of the script of the index file as a part preceded by FIG. 8;

FIG. 10 is a list showing an example of the script of the index file as a part preceded by FIG. 9;

FIG. 11 is a list showing an example of the script of the index file as a part preceded by FIG. 10;

FIG. 12 is a list showing an example of a script of a clip information file;

FIG. 13 is a list showing an example of the script of the clip information file as a part preceded by FIG. 12;

FIG. 14 is a list showing an example of the script of the clip information file as a part preceded by FIG. 13;

FIG. 15 is a flow chart describing an edit process of the record and reproduction apparatus;

FIG. 16 is a schematic diagram showing an example of the structure of directories that manage data recorded on the optical disc shown in FIG. 1;

FIG. 17 is a schematic diagram showing an example of the detailed structure of the directories shown in FIG. 16;

FIG. 18 is a list showing an example of a script of an edit list file;

FIG. 19 is a list showing an example of a script of an index file;

FIG. 20 is a list showing an example of the script of the index file as a part preceded by FIG. 19;

FIG. 21 is a list showing an example of the script of the index file as a part preceded by FIG. 20;

FIG. 22 is a list showing an example of the script of the index file as a part preceded by FIG. 21;

FIG. 23 is a list showing an example of the script of the index file as a part preceded by FIG. 22;

FIG. 24 is a list showing an example of a script of an edit list file;

FIG. 25 is a list showing an example of a part of the script of the index file;

FIG. 26 is a list showing an example of the script of the edit list file;

FIG. 27 is a list showing an example of a part of the script of the index file;

FIG. 28 is a flow chart describing a reproduction process of the record and reproduction apparatus according to an edit list;

FIG. 29 is a flow chart describing an edit process of the record and reproduction apparatus;

FIG. 30 is a list showing an example of a script of an edit list file; and

FIG. 31 is a list showing an example of a part of the script of the index file.

### BEST MODES FOR CARRYING OUT THE INVENTION

Next, embodiments of the present invention will be described. The relationship between the structural elements described in the claims and the embodiments of the present patent application is as follows. This relationship represents that examples that support the claims of the present patent application are described in the embodiments of the present patent application. Thus, even if examples corresponding to the embodiments are not described in this section, the examples should not be construed as those that do not correspond to the structural elements of the claims of the present patent application. In contrast, even if examples are described in this section as those that correspond to the structural elements of the claims, the examples should not be construed as those that do not correspond to other than the structural elements of the claims of the present patent application.

In addition, the description of this section does not mean that all aspects of the present invention that correspond to the examples described in the embodiments of the present patent application are not described in the claims of the present patent application. In other words, this description does not deny the possibility of which there are aspects of the present invention that are described in the embodiments but not described in the claims of the present patent application, namely aspects of the present invention that may be filed as divisional patent application(s) or aspects of the present invention that may be added as amendments.

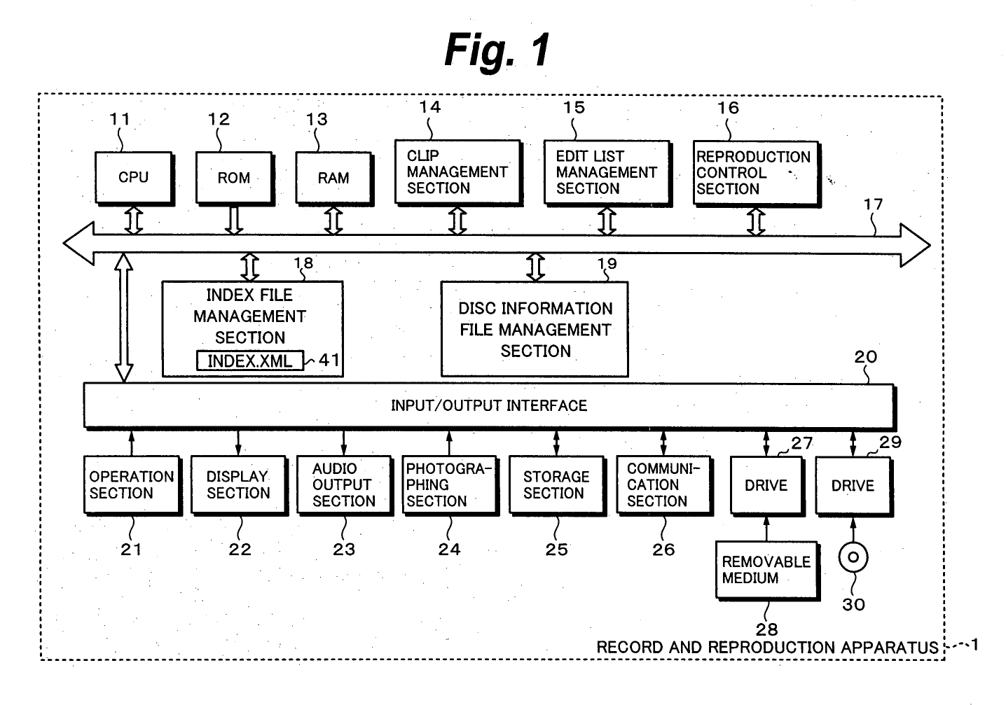

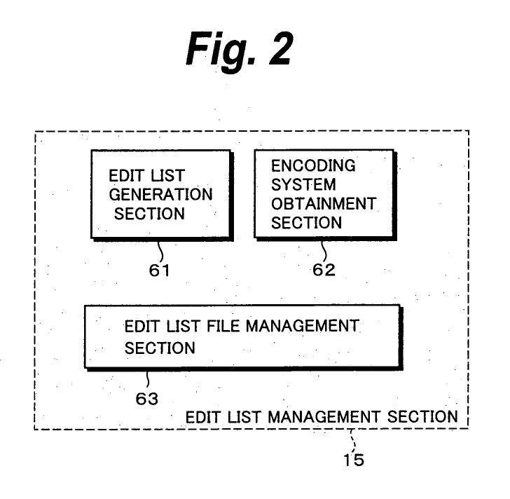

An information process apparatus (for example, a record and reproduction apparatus 1 shown in FIG. 1) of claim 1 comprises identification means (for example, an encoding system obtainment section 62 shown in FIG. 2) for identifying encoding systems for a plurality of pieces of data that have been connected and successively reproduced as an edit process; and generation means (for example, an edit list file management section 63 shown in FIG. 2) for generating one management information file (for example, an edit list file 311 shown in FIG. 17) that contains encoding system information representing the encoding systems identified by the identification means and that manages an edited result of the plurality of pieces of data.

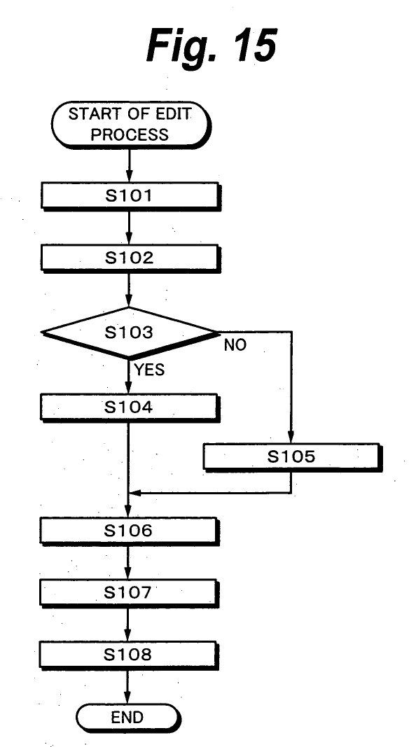

An information process method of claim 2 comprises the steps of identifying encoding systems for a plurality of pieces of data that have been connected and successively reproduced as an edit process (for example, at step S102 shown in FIG. 15); and generating one management information file (for example, an edit list file 311 shown in FIG. 17) that contains encoding system information representing the encoding systems identified at the identification step and that manages an edited result of the plurality of pieces of data (for example, at step S104 shown in FIG. 15).

Since examples of the structural elements of the record medium of claim 3 and the program of the program of claim 4 are the same as examples of the structural elements of claim 2, their description will be omitted.

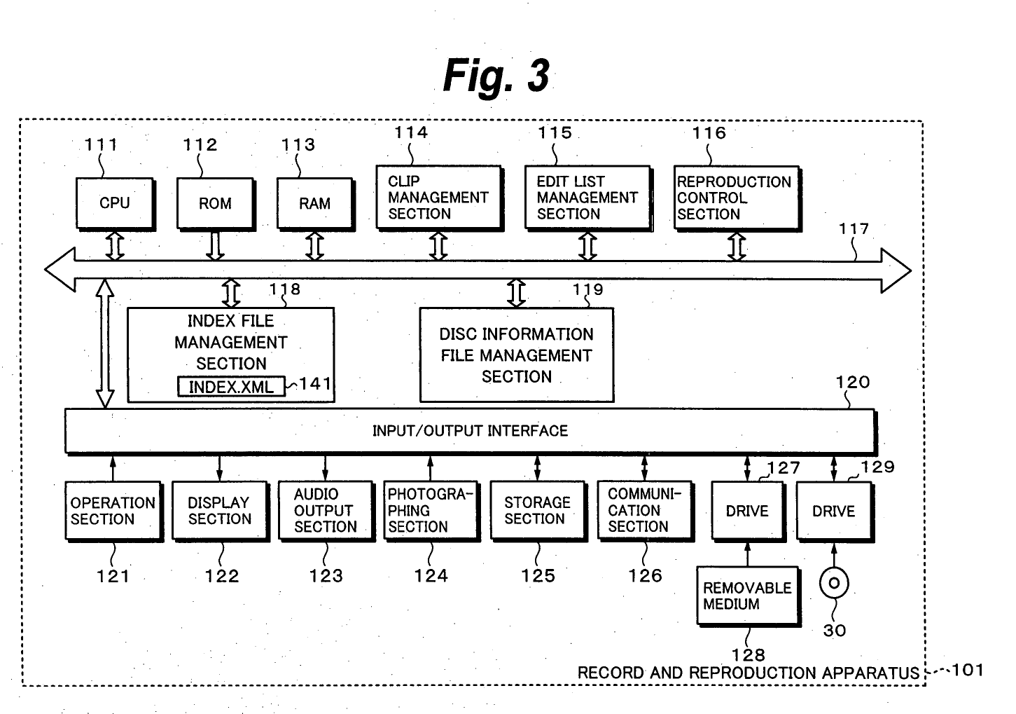

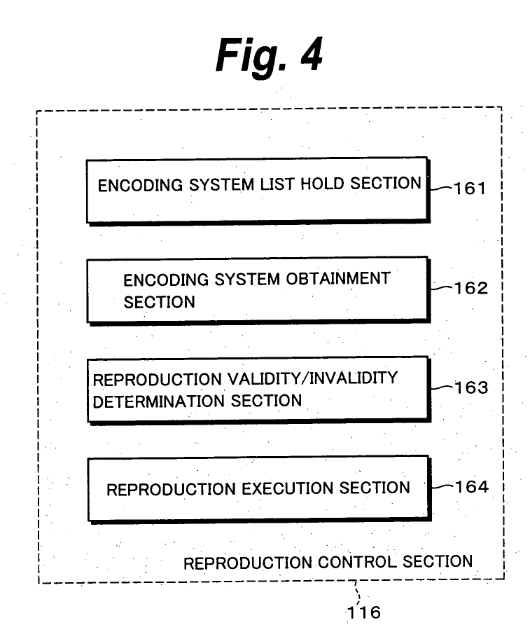

An information process apparatus (for example, an record and reproduction apparatus 101 shown in FIG. 3) of claim 5 comprises determination means (for example, a reproduction possibility determination section 163, shown in FIG. 4) for determining whether the plurality of pieces of data can be reproduced according to encoding system information that is recorded in one information file (for example, an edit list file 311 shown in FIG. 17) and that represents encoding systems for the plurality of pieces of data, the information file managing an edited result of the plurality of pieces of data.

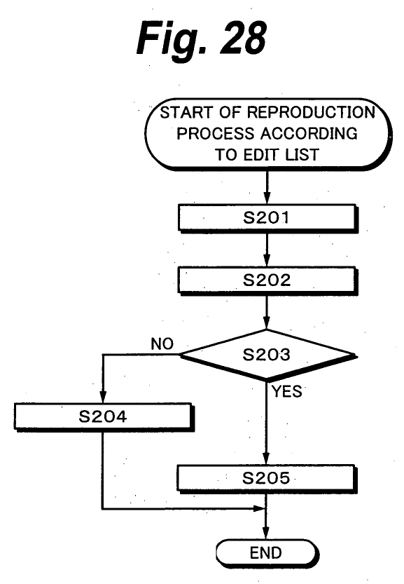

An information process method of claim 6 comprises the step of determining whether the plurality of pieces of data can be reproduced according to encoding system information that is recorded in one information file (for example, an edit list file 311 shown in FIG. 17) and that represents encoding systems for the plurality of pieces of data, the information file managing an edited result of the plurality of pieces of data (for example, at step S203 shown in FIG. 28).

Since examples of the structural elements of the record medium of claim 7 and the program of the program of claim 8 are the same as examples of the structural elements of claim 2, their description will be omitted.

Next, with reference to the accompanying drawings, an embodiment of the present invention will be described.

FIG. 1 is a block diagram showing the structure of a record and reproduction apparatus 1 according to an embodiment of the present invention.

The record and reproduction apparatus 1 shown in FIG. 1 is for example a video camera such as a Camcorder®. The record and reproduction apparatus 1 is used to collect news for broadcasting programs and photograph sports games and video contents such as movies. The record and reproduction apparatus 1 is operated by a photographing staff member and used to photograph each scene. Photographed moving picture data and audio data are recorded on a record medium such as an optical disc 30.

In addition, the record and reproduction apparatus 1 can record not only original moving picture data that are photographed moving picture data, but low resolution moving picture data (hereinafter referred to as low resolution data) on the optical disc 30. Although the data amount of the original moving picture data is large, it is high quality moving picture data. Thus, the original moving picture data are used for final video programs. In contrast, the low resolution data are moving picture data that are composed of low-pixel frames of which a predetermined number of pixels have been removed from each frame of the original moving picture data. The low resolution data may have been encoded according to for example the MPEG (Moving Picture Expert Group) 4 system. Although the picture quality of the low resolution data is inferior to that of the original moving picture data, since the data amount of the low resolution data is smaller than that of the original moving picture data, the load of the transmission process and the reproduction process for the low resolution data is lighter than that for the original moving picture data. Thus, the low resolution data are mainly used for a rough edit process and so forth.

In addition to a reproduction process for necessary moving picture data in a desired order and a display process therefore, the record and reproduction apparatus 1 also performs an edit process for collected moving picture data. There are two types of edit processes that are a rough edit process and a main edit process.

The rough edit process is a simple edit process for moving picture data and audio data. When the record and reproduction apparatus 1 obtains a plurality of pieces of data of video contents that contain moving picture data and audio data corresponding to clips each of which is a unit of a photographing process performed one time in the rough edit process (the data of the video contents are hereinafter referred to as clip data), the record and reproduction apparatus 1 selects clip data that will be used in the main edit process, selects (logs) a necessary picture portion from the selected clip data, sets up the edit start point (In point) and the edit end point (Out point) of the selected picture portion with for example a time code, and extracts (ingests) the corresponding portion from the clip data.

A clip is a unit that represents not only a photographing process performed one time, but a duration after a photographing process starts until it ends. Instead, a clip may be a unit that represents the length of one of various types of data obtained in a photographing process. Instead, a clip may be a unit that represents a data amount of one of various types of data obtained in a photographing process. Instead, a clip may be a set of various types of data.

The main edit process is a process that connects individual clip data that have been roughly edited, finally adjusts the picture quality of the connected moving picture data, and generates complete package data as a program that will be broadcast.

According to this embodiment, the record and reproduction apparatus 1 performs an photographing process, a reproduction process, and an edit process. Of course, these processes may be performed by different devices.

In FIG. 1, a CPU (Central Processing Unit) 11 executes various processes according to a program stored in a ROM (Read Only Memory) 12. When necessary, a RAM (Random Access Memory) 13 stores data, programs, and so forth that the CPU 11 uses to execute various processes.

A clip management section 14 manages a process that generates a clip and records it on the optical disc 30, a process that changes the contents of a clip recorded on the optical disc 30, a process that deletes a clip from the optical disc 30, and other processes.

When an edit process that connects clips is preformed, an edit list management section 15 generates an edit list that is information about an edited result according to information about edited contents and information about edited data. The edit list management section 15 performs a non-destructive edit process, not update various types of data to be edited.

A reproduction control section 16 controls a reproduction process for AV data recorded on the optical disc 30.

When the optical disc 30 is formatted an index file management section 18 generates an index file (INDEX.XML) 41 and records it on the optical disc 30 through a drive 29. In addition, when data recorded on the optical disc 30 are changed, for example, a clip is recorded on the optical disc 30 or an edit list is recorded on the optical disc 30, the index file management section 18 updates the contents of the index file 41 and records the updated index file 41 on the optical disc 30 through the drive 29.

A disc information file management section 19 executes a generation process and an update process for a disc information file (DISCINFO.XML) that is a file that contains a list of a reproduction history of the optical disc 30.

The CPU 11, the ROM 12, the RAM 13, the clip management section 14, the edit list management section 15, the reproduction control section 16, the index file management section 18, and the disc information file management section 19 are mutually connected through the bus 17. In addition, an input/output interface 20 is also connected to the bus 17.

Connected to the input/output interface 20 is an operation section 21 composed of buttons, dials, and so forth. An operation signal corresponding to an input operation for the operation section 21 is output to the CPU 11. Connected to the input/output interface 20 are also a display section 22 composed of an LCD (Liquid Crystal Display), an audio output section 23 composed of a speaker or the like, a photographing section 24 that photographs an image of an object and collects a sound therefrom, a storage section 25 composed of a hard disk or the like, a communication section 26 that communicates data with another device through a network such as the Internet, and a drive 27 that reads and writes data from and to a removable medium 28 composed of a record medium such as a magnetic disc, an optical disc, a magnetic-optical disc, or a semiconductor memory.

Connected to the input/output interface 20 is also a drive 29 that records data and reads data to and from the optical disc 30.

The optical disc 30 is an optical disc on which a large capacity of data (for example, 27 Gigabytes) having a mark length of 0.14 μm (minimum) and a track pitch of 0.32 μm is recorded with a blue-purple laser having for example a numerical aperture (NA) of 0.85 and a wavelength of 405 nm. The optical disc 30 may be another type of a record medium. For example, the optical disc 30 may be one of various types of optical discs such as DVD-RAM (Digital Versatile Disc-Random Access Memory), DVD-R (DVD-Recordable), DVD-RW (DVD-ReWritable), DVD+R (DVD+Recordable), DVD+RW (DVD+ReWritable), CD-R (Compact Disc-Recordable), CD-RW (CD-ReWritable), and so forth.

FIG. 2 shows an example of the internal structure of the edit list management section 15 shown in FIG. 1.

In FIG. 2, an edit list generation section 61 generates an edit list directory. An encoding system obtainment section 62 obtains encoding systems for moving picture data (video files) of clips contained in an edit list that represents an edited result of moving picture data and audio data. An edit list file, management section 63 performs a generation process, an update process, a update process, and other processes for an edit list file.

FIG. 3 shows an example of the structure of a record and reproduction apparatus 101 that is different from the record and reproduction apparatus 1 shown in FIG. 1. Since the structures of a CPU 111, a drive 129, and so forth of the record and reproduction apparatus 101 are the same as those of the CPU 11, the drive 29, and so forth of the record and reproduction apparatus 1, their description will be omitted. An optical disc 30 shown in FIG. 3 is the same as the optical disc 30 shown in FIG. 1. In other words, after the record and reproduction apparatus 1 shown in FIG. 1 has recorded a clip and a clip list on the optical disc 30, it is unloaded form the record and reproduction apparatus 1, and then loaded into the record and reproduction apparatus 101 shown in FIG. 3.

FIG. 4 shows an example of the internal structure of a reproduction control section 116 of the record and reproduction apparatus 101 shown in FIG. 3. In FIG. 4, an encoding system list hold section 161 holds a list of encoding systems for which the record and reproduction apparatus 101 can decode data. An encoding system obtainment section 162 obtains encoding systems necessary to reproduce an edit list recorded on the optical disc 30. A reproduction possibility determination section 163 determines whether the encoding systems obtained by the encoding system obtainment section 162 are contained in the list of encoding systems held in the encoding system list hold section 161 so as to determine whether the record and reproduction apparatus 101 can reproduce the edit list. A reproduction execution section 164 executes a reproduction process for clips according to an edit list that the reproduction possibility determination section 163 has determined that the record and reproduction apparatus 101 can reproduce.

Next, a file system that manages each type of data recorded on the optical disc 30 and the directory structure and files of the file system will be described.

Data recorded on the optical disc 30 are managed according to any file system such as UDF (Universal Disk Format), IS09660 (International Organization for Standardization 9660), or the like. When a magnetic disc such as a hard disk is used instead of the optical disc 30, as a file system, FAT (File Allocation Tables), NTFS (New Technology File System), HFS (Hierarchical File System), UFS (Unix (registered trademark) File System), or the like may be used. Instead, a dedicated file system may be used.

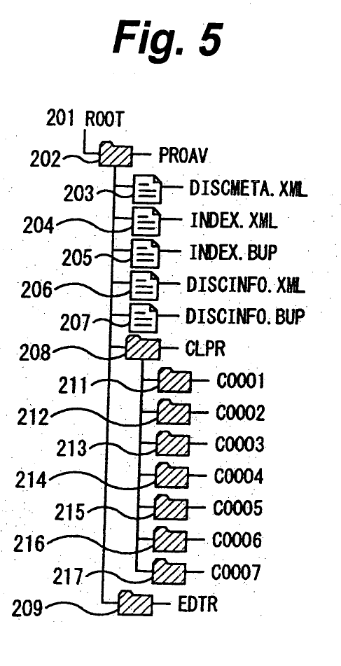

In the file system, data recorded on the optical disc 30 are managed with a directory structure and files shown in FIG. 5.

In FIG. 5, under a root directory (ROOT) 201, a PROAV directory 202 is placed. Under the PROAV directory 202, directories for information about essence data of moving picture data, audio data, and so forth, edit lists that represent edited results of essence data, and so forth are placed. In addition, under the root directory 201, a directory (not shown) for construction table data and so forth is placed.

Under the PROAV directory 202, a disc meta file (DISCMETA.XML) 203 that is a file that contains titles and comments of all essence data recorded on the optical disc 30 and information such as a path to moving picture data corresponding to a representative picture as a representative frame of all moving picture data recorded on the optical disc 30, an index file (INDEX.XML) 204 that contains management information and so forth with which all clips and edit lists recorded on the optical disc 30 are managed, and a backup file (INDEX.BUP) 205 that is a backup file of the index file 204 are placed. The backup file 205 is a copy of the index file 204. With the two files, the reliability is improved. The index file 41 shown in FIG. 1 and the index file 141 shown in FIG. 3 are the same as an index file 204 that is read from the optical disc 30.

Under the PROAV directory 202, a disc information file (DISCINFO.XML) 206 that is a file that contains meta data of all data recorded on the optical disc 30, for example information such a disc attribute, a reproduction start position, Reclnhi, or the like and a backup file (DISCINFO.BUP) 207 of the disc information file 206 are placed. The backup file 207 is a copy of the disc information file 206. With the two files, the reliability is improved.

Besides these files, under the PROAV directory 202, a clip root directory (CLPR) 208 whose lower directory contains data of clips and an edit list root directory (EDTR) 209 whose lower directory contains data of edit lists are placed.

Under the clip root directory 208, data of clips recorded on the optical disc 30 are managed with directories corresponding to clips. For example, in the case shown in FIG. 5, data of seven clips are managed with seven directories that are a clip directory (C0001) 211, a clip directory (C0002) 212, and a clip directory (C0003) 213, a clip directory (C0004) 214, a clip directory (C0005) 215, a clip directory (C0006) 216, and a clip directory (C0007) 217.

In other words, each type of data of the first clip recorded on the optical disc 30 is managed as a file placed under the clip directory 211. Each type of data of the second clip recorded in the optical disc 30 is managed as a file placed under the clip directory 212. Each type of data of the third clip recorded on the optical disc 30 is managed as a file placed under the clip directory 213. Each type of data of the fourth clip recorded on the optical disc 30 is managed as a file placed under the clip directory 214. Each type of data of the fifth clip recorded on the optical disc 30 is managed as a file placed under the clip directory 215. Each type of data of the sixth clip recorded on the optical disc 30 is managed as a file placed under the clip directory 216. Each type of data of the seventh clip recorded on the optical disc 30 is managed as a file placed under the clip directory 217.

Under the edit list root directory 209, edit lists recorded on the optical disc 30 as results of an edit process (described later) performed a plurality of number of times are managed with different directories. FIG. 5 shows the state of which an edit process has been performed. Thus, under a lower directory of the edit list root directory 209, an edit list directory is not recorded. However, whenever an edit process is executed one time, one edit list directory is generated under the edit list root directory 209. With the generated edit list directory, files generated as the edited result are managed. In other words, when the first edit process is executed, an edit list directory with which files generated as the results of the first edit process are managed is generated. When the second edit process is executed, an edit list directory with which files generated as the results of the second edit process are managed is generated. When the third edit process is executed, an edit list directory with which files generated as the results of the third edit process are managed is generated. Likewise, when the fourth or later edit process is executed, an edit list directory with which files generated as the result of the edit process are managed is generated.

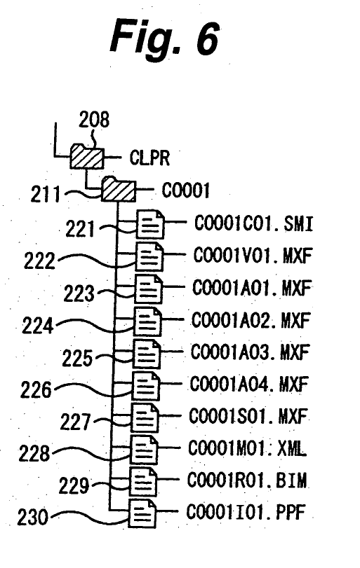

Under a lower directory of the clip directory 211 under the clip root directory 208, files of individual types of data of a clip recorded first on the optical disc 30 are placed and managed as shown in FIG. 6.

In the case shown in FIG. 6, under the clip directory 211, a clip information file (C0001C01.SMI) 221 that is a file that manages the clip, a video file (C0001V01.MXF) 222 that is a file that contains moving picture data of the clip, four audio data files (C0001A01.MXF to C0001A04.MXF) 223 to 226 that are four files that contain audio data of individual channels of the clip, a low resolution data file (C0001S01.MXF) 227 that is a file that contains low resolution data corresponding to the moving picture data of the clip, a clip metadata file (C0001M01.XML) 228 that is a file that contains clip meta data such as a conversion table that correlates LTC (Longitudinal Time Cord) and frame number as meta data that do not need to be in real time corresponding to essence data of the clip, a frame meta data file (C0001R01.BIM) 229 that is a file that contains frame meta data that are meta data for example LTC that need to be in real time corresponding to essence data of the clip, a picture pointer file (C0001I01.PPF) 230 that is a file that contains the frame structure of the video file 222 (for example, information about the compression format of each picture in MPEG or the like and information of an offset address from the beginning of the file), and so forth are placed. The clip information file 221 contains information about the encoding system of moving picture data contained in the video file 222.

In the case shown in FIG. 6, moving picture data, low resolution data, and frame meta data that are data that need to be reproduced in real time are managed as different files so that their read times do not increase.

Likewise, audio data need to be reproduced in real time. To deal with audio data of multi channels, four channels are provided. They are managed with different files. In the foregoing example, audio data are managed with four files. Instead, audio data may be managed with three files or less or five files or more.

Likewise, when necessary, moving picture data, low resolution data, and frame meta data may be managed with two or more files each.

In FIG. 6, clip meta data that do not need to be in real time are managed with a file different from a file for frame meta data that need to be in real time. This is because meta data are prevented from being unnecessarily reproduced while moving picture data and so forth are being normally reproduced. Thus, the process time for the reproduction process can be shortened and the load of the process can be lightened.

To allow the clip meta data file 228 to have versatility, the clip meta data file 228 has the XML (extensible Markup Language) format. However, to shorten the process time for the reproduction process and lighten the load of the process, the frame meta data file 229 is a BIM format file of which an XML format file has been compiled.

The example of the structure of the files in the clip directory 211 shown in FIG. 6 can be applied to all clip directories for clips recorded on the optical disc 30. In other words, the example of the structure of the files shown in FIG. 6 can be applied to the other clip directories 212 to 217 shown in FIG. 5. Thus, their description will be omitted.

Individual files contained in a clip directory for one clip were described. However, the structure of these files is not limited to the foregoing example. Instead, any structure may bemused as long as a clip meta data file of a clip is placed in a lower director of each clip directory.

A deletion permission/prohibition flag can be set to each of the clip directories 211 to 217. For example, when the user does not want to delete the video files 222 and the audio files 223 to 226 in the clip directory 211, he or she can issues a deletion prohibition command for the clip directory 211 through the operation section 21. At this point, a deletion prohibition flag is set to the clip directory 211. In this case, even if the user mistakenly issues the deletion command for a file (for example, the video file 222) in the clip directory 211, the file can be prevented from being deleted. Thus, a file that the user needs can be prevented from being mistakenly deleted. When a clip information file, a video file, audio files, a low resolution file, a clip meta data file, a frame meta data file, and a picture pointer file that are generated by a photographing process performed one time are recorded together in a clip directory and the deletion prohibition flag is set to the clip directory, the user does not need to set the deletion prohibition flag to the individual files. Thus, the user's operation can be simplified.

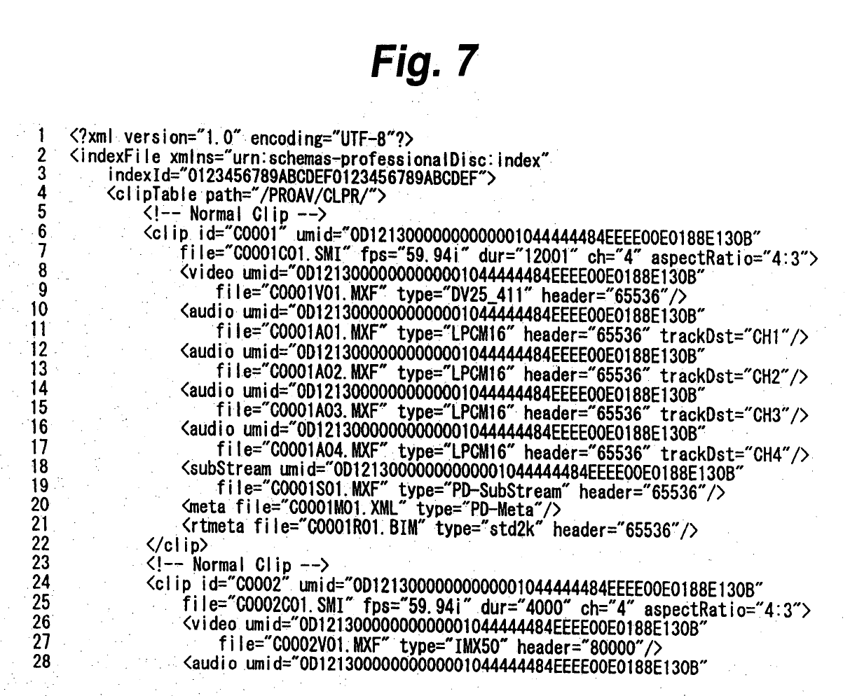

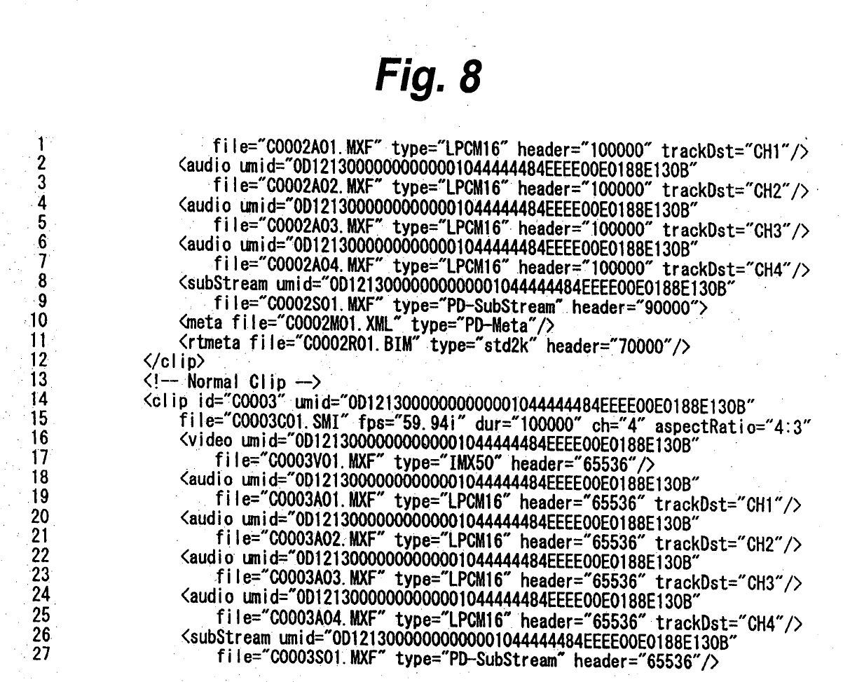

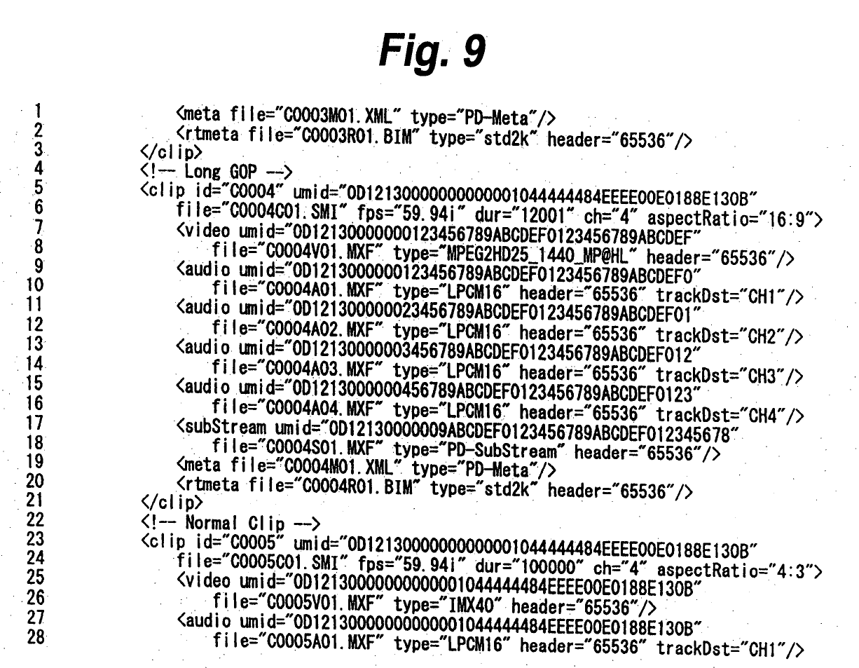

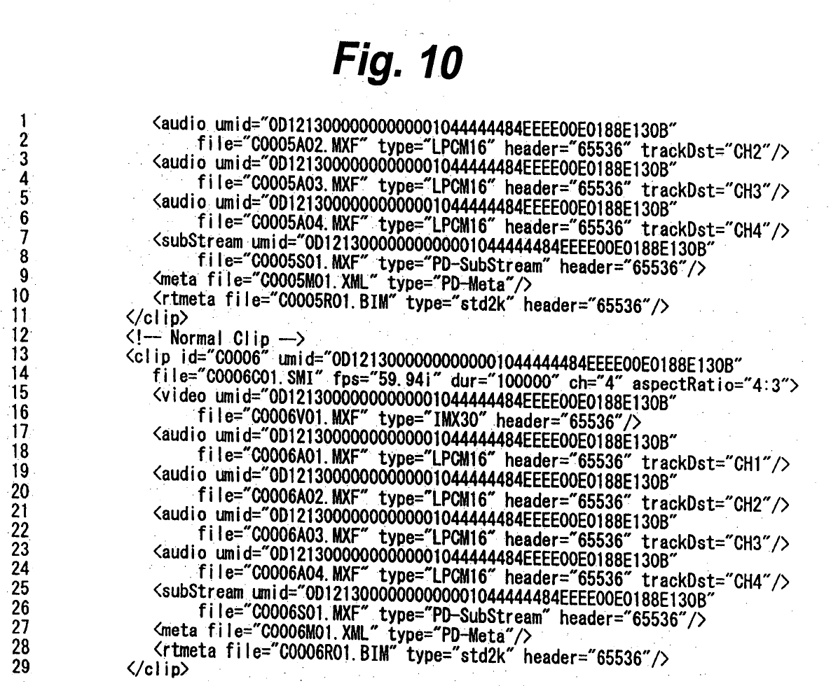

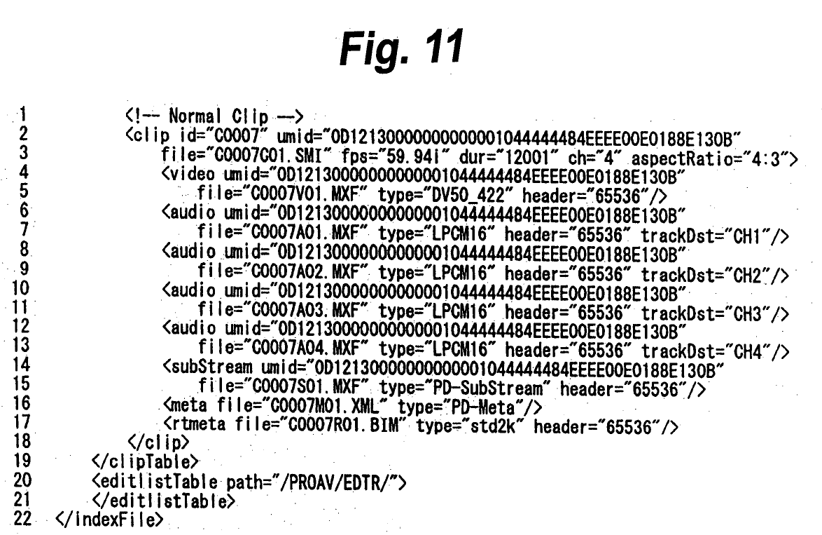

FIG. 7 to FIG. 11 show an example of a script of the index file 204 (41, 141). FIG. 8 shows a part of the script preceded by FIG. 7. FIG. 9 is a part of the script preceded by FIG. 8. FIG. 10 is a part of the script preceded by FIG. 9. FIG. 11 is a part of the script preceded by FIG. 10.

In [<?xml version=“1.0” encoding=“UTF-8” line 1, FIG. 7, [xml version=“1.0”] represents that the index file 204 is an XML document. [encoding=“UTF-8”] represents that character code is UTF-8, fixed. [<indexFile xmlns=“urn:schemas-professionalDisc: index”], line 2, FIG. 7, represents a name space of the XML document. [indexId “0123456789ABCDEF0123456789 ABCDEF”>], line 3, FIG. 7, represents an ID (Identification) that globally and uniquely identifies the index file 204 itself. In this example, the ID of the index file 204 is [0123456789ABCDEF0123456789 ABCDEF].

<clipTable path=“/PROAV/CLPR/”], line 4, FIG. 7, represents an absolute path of the directory of the clip on the disc. In other words, [/PROAV/CLPR/] represents that the clip is recorded under the clip root directory 208 under the PROAV directory 202. [<!--Normal Clip-->] represents that information about a normal clip starts from the next line. In [<clip id=“C0001” umid=“0D12130000000000001044444484 EEEE00E0188E130B”], line 6, FIG. 7, [id=“C0001”] represents the ID of the clip (hereinafter also referred to as the clip ID). In this example, this expression represents that the clip ID is [C0001]. The clip ID is the same as the clip directory name. In other words, in clip ID [C0001], the name of the clip directory 211 is used as an ID. [umid=“0D1213000000 0000001044444484EEEE00E0188E130B] represents the UMID of the clip of clip ID [C0001]. In this example, this expression represents that the UMID is [0D1213000000000 0001044444484EEEE00E0188E130B].

In [file=“C0001C01.SMI” fps=“59.94i” dur=“12001” ch=“4” aspectRatio=“4:3”>], line 7, FIG. 7, [file=C0001C01.SMI”] represents the file name of the clip information file 221. In this example, this expression represents that the file name of the clip information file 221 is [C0001C01.SMI]. [fps “59.94i”] represents the resolution of the clip in the time base direction in the unit of field/sec. In this example, this expression represents the signal frequency according to the NTSC system. [dur=“12001”] represents the valid length of the clip in the time direction in the unit of frames. Thus, the duration of one frame can be obtained with the fps attribute. In other words, [12001] represents that the moving picture data of this clip has a duration of 12001 frames. [ch=“4”.] represents the number of audio channels contained in the clip. In this example, this expression represents that the number of audio channels is four. This value corresponds to the number of audio files 223 to 226 contained in the clip directory 211 shown in FIG. 6. [aspectRatio=“4:3”] represents the aspect ratio of the video file 222 contained in the clip. In the example, this expression represents that the aspect ratio is 4:3.

[<video umid=“0D12130000000000001044444484 EEEE00E0188E130B”], line 8, FIG. 7, represents an attribute of a video element. [umid=“0D12130000000 000001044444484EEEE00E0188E130B” represents the UMID of the video file 222. In this example, this expression represents that the UMID of the video file 222 is [0D12130000000000001044444484EEEE00E0188E130B].

[file=“C0001V01.MXF.” type=“DV25_{—}411” header=“65536”/>], line 9, FIG. 7, represents attributes of the video element as an expression preceded by the expression of line 8. [file=“C0001V01.MXF”] represents the file name of the video file 222. In this example, this expression represents [C0001V01.MXF] as the file name of the video file 222. [type=“DV25_{—}411”] represents the encoding system (file format) of the video file 222. In this example, this expression represents [DV25_{—}411] as the encoding system. DV25_{—}411 is one of DV (Digital Video) standards. [header=“65536”] represents the header size of the video file 222 in the unit of bytes. This expression represents that body data start from the position for which the file is sought from the beginning for the header size. In this example, this expression represents that the header size is 65536 bytes.

[<audio umid=“0D121300000000000010 44444484EEEE00E0188E130B”], line 10, FIG. 7, represents an attribute of an audio element. [umid=“0D12130000000000001044444484EEEE00E0188E130B”] represents the UMID of the audio file 223. In this example, this expression represents that the UMID of the audio file 223 is [0D12130000009000001044444484 EEEE00E0188E130B].

[file=“C0001A01.MXF” type=“LPCM16” header=“65536” trackDst=“CH1”/>], line 11, FIG. 7, represents attributes of the audio element of the audio file 223 as an expression preceded by the expression of line 10. [file=“C0001A01.MXF”] represents the file name of the audio file 223. In this example, this expression represents [C0001A01.MXF] as the file name. [type=“LPCM16”] represents the file format of the audio file 223. In this example, this expression represents [LPCM16] as the file format. In addition, [header=“65536”] represents the header size of the audio file 223 in the unit of bytes. In this example, the expression represents that the header size is 65536 bytes. [trackDst=“CH1”] represents an audio channel of an audio output of the audio file 223. In this example, this expression represents [CH1] as the audio channel of the audio output.

[<audio umid=“0D121300000000000010 44444484EEEE00E0188E130B”], line 12, FIG. 7, represents an attribute of an audio element. [umid=“0D12130000 000000001044444484EEEE00E0188E130B”] represents the UMID of the audio file 224. In this example, this expression represents that the UMID of the audio file 224 is [0D12130000000000001044444484EEEE00E0188E130B].

[file=“C0001A02.MXF” type=“LPCM16” header “65536” trackDst=“CH2”/>], line 13, FIG. 7, represents attributes of the audio element of the audio file 224 as an expression preceded by the expression of line 12. [file=“C0001A02.MXF”] represents the file name of the audio file 224. In this example, this expression represents [C0001A02.MXF] as the file name. [type=“LPCM16”] represents the file format of the audio file 224. In this example, this expression represents. [LPCM16] as the file format. In addition, [header=“65536”] represents the header size of the audio file 224 in the unit of bytes. In this example, the expression represents that the header size is 65536 bytes. [trackDst=“CH2”] represents an audio channel of an audio output of the audio file 224. In this example, this expression represents [CH2] as the audio channel of the audio output.

[<audio umid=“0D121300000000000010 44444484EEEE00E0188E130B”], line 14, FIG. 7, represents an attribute of an audio element. [umid=“0D12130000 000000001044444484EEEE00E0188E130B,”] represents the UMID of the audio file 225. In this example, this expression represents that the UMID of the audio file 225 is [0D1213000000000001044444484EEEE00E0188E130B].

[file=“C0001A03.MXF” type=“LPCM16” header=“65536” trackDst=“CH3”/>], line 15, FIG. 7, represents attributes of the audio element of the audio file 225 as an expression preceded by the expression of line 14. [file=“C0001A03.MXF”] represents the file name of the audio file 225. In this example, this expression represents [C0001A03.MXF.] as the file name. [type=“LPCM16”] represents the file format of the audio file 225. In this example, this expression represents [LPCM16] as the file format. In addition, [header=“65536”] represents the header size of the audio file 225 in the unit of bytes. In this example, the expression represents that the header size is 65536 bytes. [trackDst=“CH3”] represents an audio channel of an audio output of the audio file 225. In this example, this expression represents [CH3] as the audio channel of the audio output of the audio file 225.

[<audio umid=“0D121300000000000010 44444484EEEE00E0188E130B”], line 16, FIG. 7, represents an attribute of an audio element. [umid=“0D12130000 000000001044444484EEEE00E0188E130B”] represents the UMID of the audio file 226. In this example, this expression represents that the UMID of the audio file 226 is [0D12130009000000001044444484EEEE00E0188E130B].

[file=“C0001A04.MXF” type=“LPCM16” header=“65536.” trackDst=“CH4”/>], line 17, FIG. 7, represents attributes of the audio element of the audio file 226 as an expression preceded by the expression of line 16. [file=“C0001A04.MXF”] represents the file name of the audio file 226. In this example, this expression represents [C0001A04.MXF] as the file name. [type=“LPCM16”] represents the file format of the audio file 226. In this example, this expression represents [LPCM16] as the file format. In addition, [header=“65536”] represents the header size of the audio file 226 in the unit of bytes. In this example, the expression represents that the header size is 65536 bytes. [trackDst=“CH4”] represents an audio channel of an audio output of the audio file 226. In this example, this expression represents [CH4] as the audio channel of the audio output of the audio file 226.

[<subStream umid=“0D121300000000000010 44444484EEEE00E0188E130B”], line 18, FIG. 7, represents an attribute of a subStream element, namely the low resolution data file 227. [umid=“0D1213000000000000 1044444484EEEE00E0188E130B”] represents the UMID of the low resolution data file 227. In this example, this expression represents that the UMID of the low resolution data file 227 is [umid=“0D12130000000000 001044444484EEEE00E0188E130B].

[file=“C0001S01.MXF” type=“PD-SubStream” header=65536”/>], line 19, FIG. 7, represents attributes of the low resolution data file 227 as an expression preceded by the expression of line 18, FIG. 6. [file=“C0001S01.MXF”) represents the file name of the low resolution data file 227. In this example, this expression represents [C0001S01.MXF] as the file name of the low resolution data file 227. [type=“PD-SubStream”] represents the file format of the low resolution data file 227. In this example, this expression represents [PD-SubStream] as the file format of the low resolution data file 227. [header=“65536”] represents the header size of the low resolution data file 227. In this example, this expression represents [65536] as the header size. This expression represents that the header size of the low resolution data file 227 is 65536 bytes.

[<meta file=“C0001M01.XML” type=“PD-Meta”/>.], line 20, FIG. 7, represents an attribute of the clip meta data file 228. This meta element manages information about the clip meta data file 228. [file=“C0001M01.XML] represents the file name of the clip meta data file 228. In this example, this expression represents [C0001M01.XML] as the file name of the clip meta data file 228. [type=“PD-Meta”] represents the file format of the clip meta data file 228. According to this embodiment, this expression represents [PD-Meta] as the file format of the clip meta data file 228.

[<rtmeta file=“C0001R01.BIM” type=“std2k” header=“65536”/>], line 21, FIG. 7, represents attributes of the frame meta data file 229. A real time meta element manages information about the frame meta data file 229. [file=“C0001R01.BIM”] represents the file name of the frame meta data file 229. In this example, this expression represents [C0001R01.BIM] as the file name of the frame meta data file 229. [type=“std2k”] represents the file format of the frame meta data file 229. In this example, this expression represents. [std2k] as the file format of the frame meta data file 229. [header=“65536”] represents the header size of the frame meta data file 229. In this example, this expression represents [65536] as the header size of the frame meta data file 229. This expression represents that the header size is 65536 bytes.

[</clip>], line 22, FIG. 7, represents that the attributes of the files of the clip of clip ID [C0001], namely the files recorded in the clip directory 221, end. In other words, information about one clip of clip ID [C0001] is written from line 5 to line 22, FIG. 7.

Attributes of a clip of clip ID [C0002], namely files recorded in the clip directory 212, are, written from line 23, FIG. 7 to line 12, FIG. 8. Since the items of the attributes of the clip of clip ID [C0002] are basically the same as those of the clip of clip ID [C0001], their detailed description will be omitted. [type=“IMX50”], line 27, FIG. 7, represents the encoding system of a video file (moving picture data) managed under the clip directory 212. This expression represents that the encoding system of the video file (moving picture data) is [IMX50]. IMX is an encoding system of which video data are composed of only I pictures of MPEG.

Attributes of a clip of clip ID [C0003], namely files recorded in the clip directory 213, are written from line 13, FIG. 8 to line 3, FIG. 9. Since the items of the attributes of the clip of clip ID [C0003] are basically the same as those of the clip of clip ID [C0001], their detailed description will be omitted. [type=“IMX50”], line 17, FIG. 8, represents the encoding system of a video file (moving picture data) managed under the clip directory 213. This expression represents that the encoding system of the video file (moving picture data) is [IMX50]. IMX is an encoding system of which video data are composed of only I pictures of MPEG.

Attributes of a clip of clip ID [C0004], namely files recorded in the clip directory 214, are written from line 4, FIG. 9 to line 21, FIG. 9. Since the items of the attributes of the clip of clip ID [C0004] are basically the same as those of the clip of clip ID [C0001], their detailed description will be omitted. [type=“MPEG2HD25_{—}1440.MP@HL”], line 8, FIG. 9, represents the encoding system of a video file (moving picture data) managed under the clip directory 214. This expression represents that the encoding system of the video file (moving picture data) is [MPEG2HD25_{—}1440 MP@HL]. MPEG2HD25_{—}1440_MP@HL is an encoding system according to MPEG Long GOP.

Attributes of a clip of clip ID [C0005], namely files recorded in the clip directory 215, are written from line 22, FIG. 9 to line 11, FIG. 10. Since the items of the attributes of the clip of clip ID [C0005] are basically the same as those of the clip of clip ID. [C0001], their detailed description will be omitted. [type=“IMX40”], line 26, FIG. 9, represents the encoding system of a video file (moving picture data) managed under the clip directory 215. This expression represents that the encoding system of the video file (moving picture data) is [IMX40].

Attributes of a clip of clip ID [C0006], namely files recorded in the clip directory 216, are written from line 12, FIG. 10 to line 29, FIG. 10. Since the items of the attributes of the clip of clip ID [C0006] are basically the same as those of the clip of clip ID [C0001], their detailed description will be omitted. [type=“IMX30”], line 16, FIG. 10, represents the encoding system of a video file (moving picture data) managed under the clip directory 216. This expression represents that the encoding system of the video file (moving picture data) is (IMX30].

Attributes of a clip of clip ID [C0007], namely files recorded in the clip directory 217, are written from line 1, FIG. 11 to line 18, FIG. 11. Since the items of the attributes of the clip of clip ID [C0007] are basically the same as those of the clip of clip ID [C0001], their detailed description will be omitted. [type=“DV50_{—}422”], line 5, FIG. 11, represents the encoding system of a video file (moving picture data) managed under the clip directory 217. This expression represents that the encoding system of the video file (moving picture data) is [DV50_{—}422].

[<clipTable>], line 19, FIG. 11, represents that information about the clips ends. In other words, management information (attributes) of seven clips of clip IDs [C0001] to [C0007] are written from line 4, FIG. 7 to line 19, FIG. 11.

[<editlistTable path=“/PROAV/EDTR/”>], line 20, FIG. 11, represents the absolute path of the directory of the edit list on the disc. In this example, this expression represents that the edit list is recorded under the edit list root directory 209 under the PROAV directory 202.

[<editlistTable>], line 21, FIG. 11, represents that the management information of the edit list that starts from line 20, FIG. 11, ends. In this example, this expression represents an example of which no edit list has not been generated. When an edit list is generated by an edit process, management information (attribute) of the generated edit list is written between line 20 and line 21, FIG. 11.

[</indexFile>], line 22, FIG. 11, represents that information about the index file 204 ends.

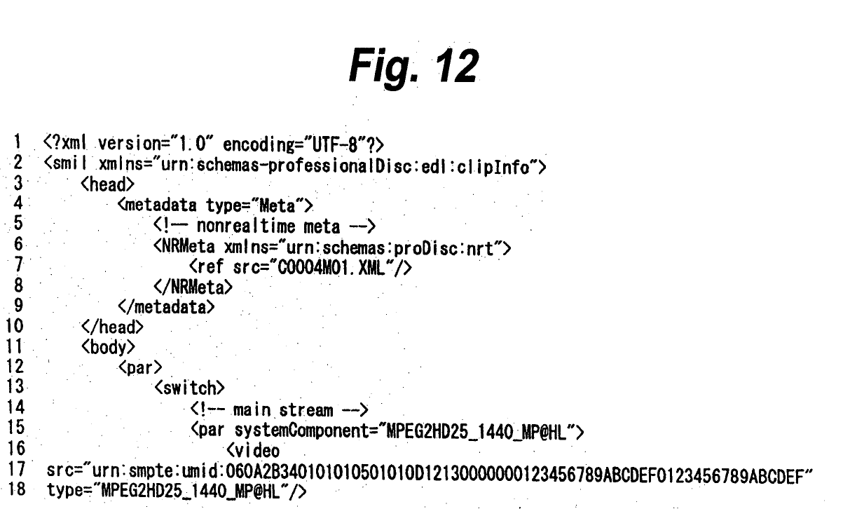

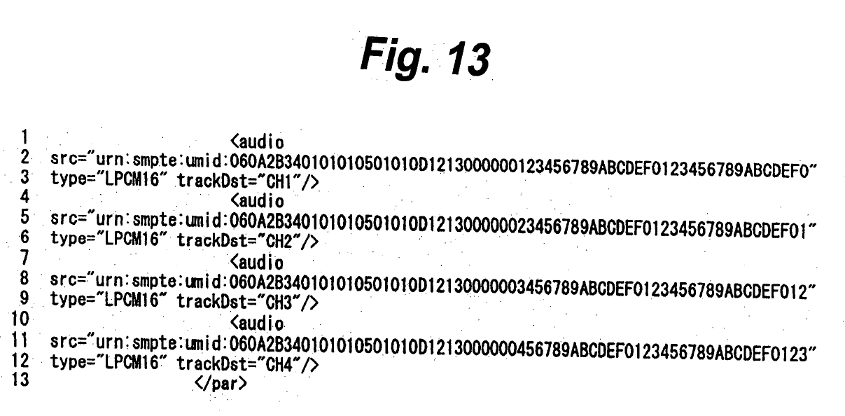

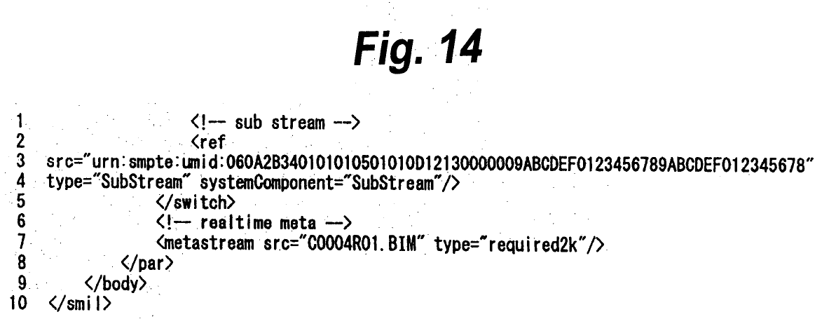

FIG. 12 to FIG. 14 show an example of a script of a clip information file placed under the clip directory 214. FIG. 13 shows a part of the script preceded by FIG. 12. FIG. 14 shows a part of the script preceded by FIG. 13.

In [<?xml version=“1.0” encoding=“UTF-8”?>], line 1, FIG. 12, [xml version=“1.0”] represents that the clip information file is an XML document. [encoding=“UTF-8”] represents that the character code is UTF-8, fixed.

[<smil xmlns=“urn:schemas-professionalDisc: ed1:clipInfo>] represents a name space of the XML document.

[<head>] line 3, FIG. 12, represents that a header starts. In other words, the script of the clip information file is composed of a header portion and a body portion. The header is followed by the body. [<metadata type=“Meta”>], line 4, FIG. 12, represents the file format of the clip information file. In the example shown in FIG. 12, this expression represents [Meta] as the file format. [<!--nonrealtime meta-->], line 5, FIG. 12, represents that information about a clip meta data file starts from line 6. [<NRMeta xmlns=“urn:schemas:proDisc:nrt”>], line 6, FIG. 12, represents a name space of the clip meta data file. [<ref src=“C0004M01.XML”/>], line 7, FIG. 12, represents a source name to be referenced. In the example shown in FIG. 12, this expression represents [C0004M01.XML] as the file name of the clip meta data file. [</NRMeta>], line 8, FIG. 12, represents that information about the clip meta data file ends. [</metadata>], line 9, FIG. 12, represents that information about the meta data that starts from line 4 ends. [</head>], line 10, FIG. 12, represents that the header that starts from line 3 ends.

[<body>], line 11, FIG. 12, represents that the body portion of the clip information file starts. [<par>], line 12, FIG. 12, represents that data are reproduced in parallel. [<switch>], line 13, FIG. 12, represents that data are selectively reproduced. [<!--main stream-->], line 14, FIG. 12, represents that information about AV data of a main stream starts. The main stream represents high resolution data (video file and audio file) corresponding to low resolution data. In [<par systemComponent=“MPEG2HD25_{—}1440_MP@HL”>, line 15, FIG. 12, [par] represents that data written in line 16, FIG. 12 to line 12, FIG. 13, are reproduced in parallel. [systemComponent=“MPEG2HD25_{—}1440 MP@HL”] represents the encoding system (file format) of a video file. In the example shown in FIG. 13, this expression represents [MPEG2HD25_{—}1440 MP@HL] as the file format. This encoding system is Long GOP of MPEG.

In [<video src=“urn:smpte:umid:060A2B34010 1010501010D12130000000123456789ABCDEF0123456789ABCDEF” type=MPEG2HD25_{—}1440_MP@HL”/>, line 16 to line 18, FIG. 12, [umid:060A2B340101010501010D12130000000 123456789ABCDEF0123456789ABCDEF] represents the UMID of the video file. In this example, this expression represents that the UMID of the video file is [060A2B34 0101010501010D12130000000123456789ABCDEF0123456789ABCDE F]. [type=“MPEG2HD25_{—}1440 MP@HL”] represents the file format of the video file. In this example, this expression represents [MPEG2HD25_{—}1440_MP@HL] as an example of the file format of the video file.

The expression of line 18, FIG. 12, is followed by an expression of line 1, FIG. 13. In [<audio src=“urn:smpte:umid:060A2B340101010501010 D12130000000123456789ABCDEF0123456789ABCDEF0” type=“LPCM16” trackDst “CH1”/>], line 1 to line 3, FIG. 13, [umid:060A2B340101010501010D12130000000123456789ABCDEF00 0123456789ABCDEF0] represents the UMID of the first audio file. In this example, this expression represents that the UMID of this audio file is [umid:060A2B340101010501010D12130000000123456789ABCDEF0 123456789ABCDEF0]. [type=“LPCM16”] represents the file format of the audio file. [trackDst=“CH1”] represents an audio channel of an audio output of this audio file. In this example, this expression represents [CH1] as the audio channel of the audio output of the audio file.

In [<audio src=“urn:smpte:umid:060A2B34 0101010501010D12130000000123456789ABCDEF0123456789ABCDE F01” type=“LPCM16” trackdst=“CH2”/>], line 4 to line 6, FIG. 13, [umid:060A2B340101010501010D1213000000 0123456789ABCDEF0123456789ABCDEF01] represents the UMID of the second audio file. In this example, this expression represents that the UMID of this audio file is [umid:060A2B340101010501010D1213000000123456789 ABCDEF0123456789ABCDEF01]. [type=“LPCM16”] represents the file format of the audio file. [trackDst=“CH2”] represents an audio channel of an audio output of this audio file. In this example, this expression represents [CH2] as the audio channel of the audio output of the audio file.

In [<audio src “urn:smpte:umid:060A2B34 00101010501010D12130000000123456789ABCDEF0123456789ABCDE F012” type=“LPCM16” trackDst=“CH3”/>], line 7 to line 9, FIG. 13, [umid:060A2B340101010501010D1213 0000000123456789ABCDEF0123456789ABCDEF012.] represents the UMID of the third audio file. In this example, this expression represents that the UMID of this audio file is [umid:060A2B340101010501010D1213000000012345 6789ABCDEF0123456789ABCDEF012]. [type=“LPCM16”] represents the file format of the audio file. [trackDst=“CH3”] represents an audio channel of an audio output of this audio file. In this example, this expression represents [CH3] as the audio channel of the audio output of the audio file.

In [<audio src=“urn:smpte:umid:060A2B34 0101010501010D12130000000123456789ABCDEF0123456789ABCDE F0123” type=“LPCM16” trackDst=“CH4”/>], line 10 to line 12, FIG. 14, [umid:060A2B34011010501010D1213 0000000123456789ABCDEF0123456789ABCDEF0123] represents the UMID of the fourth audio file. In this example, this expression represents that the UMID of this audio file is [umid:060A2B340101010501010D12130000000123456 789ABCDEF0123456789ABCDEF0123]. [type=“LPCM16”] represents the file format of the audio file. [trackDst=“CH4”] represents an audio channel of an audio output of this audio file. In this example, this expression represents [CH4] as the audio channel of the audio output of the audio file.

[</par>], line 13, FIG. 13 represents that information about the parallelly reproduced data that starts from line 15, FIG. 12, ends. In other words, information about a parallel reproduction for a video file and four audio files of four channels is written from line 15, FIG. 12 to line 13, FIG. 13.

The expression of line 13, FIG. 13, is followed by an expression of line 1, FIG. 14. [<!--sub stream-->], line 1, FIG. 14, represents that information about a low resolution data file starts from line 2. [<ref src=“urn:smpte:umid: 060A2B340101010501010D12130000000123456789ABCD EF0123456789ABCDEF012345678” type=“SubStream” systemComponent=“SubStream”/>] represents the UMID of the low resolution data file. In this example, this expression represents [060A2B340101010501010D 12130000000123456789ABCDEF0123456789ABCDEF012345678] as the UMID. [type=“SubStream”] represents that the low resolution data file is a sub stream. [systemComponent=“SubStream”] represents a file format. In this example, this expression represents [SubStream] as the file format.

[</switch>], line 5, FIG. 14, represents information corresponding to the expression of line 13, FIG. 12. This expression represents that one of main stream or low resolution data is selected and reproduced. In other words, this expression represents that a video file and audio files or a low resolution file is selected and reproduced.

[<!--realtime meta-->], line 6, FIG. 14, represents that information about a frame meta data file starts from line 7. In [<metastream src=C0004R01.BIM” type=“required2k”/], line 7, FIG. 14, [C0004R01.BIM] represents the file name of a frame meta data file. [type=“required2k”] represents the file format of the frame meta data file.

[</par>], line 8, FIG. 14, represents information corresponding to the expression of line 12, FIG. 12. This expression represents that one of main stream and low resolution data and the frame meta data file are reproduced in parallel.

[</body>], line 9, FIG. 14, represents information corresponding to the expression of line 11, FIG. 12. This expression represents that the body portion ends. [</smil>], line 10, FIG. 14, represents information corresponding to the expression of line 2, FIG. 12. This expression represents that smil ends.

Next, with reference to a flow chart shown in FIG. 15, an edit process of the record and reproduction apparatus 1 shown in FIG. 1 will be described.

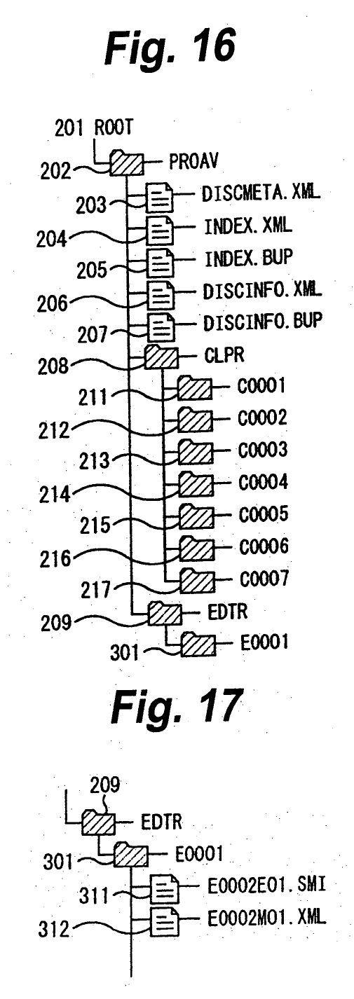

When the user operates the operation section 21 and inputs a command that causes video files of more than one clip to be connected, the flow advances to step S101. At step S101 the edit list generation section 61 generates an edit list directory under the edit list root directory 209. FIG. 16 shows an example of an edit list directory 301 generated under the edit list root directory 209 by the process at step. S101. In FIG. 16, the edit list directory (E0001) 301 is generated under the edit list root directory 209.

At step S102, the encoding system obtainment section 62 identifies all encoding systems of clips to be connected according to the command inputted by the user. In other words, the encoding system of the video file (for example, the video file 222) to be connected according to the command inputted by the user has been recorded in the index file 204 and the clip information file (for example, the clip information file 221) (see line 9, FIG. 7; line 27, FIG. 7; line 17, FIG. 8; line 8, FIG. 9; line 26, FIG. 9; line 16, FIG. 10; line 5, FIG. 11; and line 18, FIG. 12). Thus, the encoding system obtainment section 62 searches the index file 204 (or the clip information file) for the type attribute of the video file, and reads the encoding system of the video file contained in the clip to be connected according to the command inputted by the user. When the user has inputs a command that causes video files of three clips to be connected, the encoding system obtainment section 62 searches each video file to be connected according to the command for the type attribute and identifies the encoding system of each video file.

At step S103, the edit list file management section 63 determines whether the number of types of encoding systems of video files contained in the clips to be connected according to the command inputted by the user is one. When the determined result represents that the number of types of encoding systems of video files contained in the clips to be connected according to the command inputted by the user is one, the flow advances to step S104. In other words, when the command that causes video files of three clips to be connected has been inputted, the flow advances to step. S102. At step S102, the encoding systems of three video files to be connected are identified. At step s103, the edit list file management section 63 determines whether all the types of encoding systems of the three video files identified at step S102 are the same (whether the number of types of encoding systems is one). When all the types of encoding systems of the three video files are the same (namely, the number of types of encoding systems is one), the flow advances to step S104.

At step S104, the edit list file management section 63 generates an edit list file that contains information about one encoding system identified at step S102 and records the edit list file under the edit list directory 301 on the optical disc 30 through the drive 29. Thereafter, the flow advances to step S106. When the determined result at step S103 represents that the number of types of encoding systems is not one (namely, two or more), the flow advances to step S10. When the command that causes video files of three clips to be connected has been inputted at step S103, the edit list file management section 63 determines whether all encoding systems of three video files identified at step S102 are the same (whether the number of types of encoding systems is one). When the determined result represents that all the types of encoding systems of the three files are not the same (there are a plurality of encoding systems), the flow advances to step S105.

At step S105, the edit list file management section 63 generates an edit list file that contains an expression of a group name that includes a plurality of types of encoding systems identified at step S102 and records the edit list file under the edit list directory 301 on the optical disc 30 through the drive 29.

In other words, types of encoding systems are for example [DV25_{—}411], [DV25DATA_{—}411], [DV25_{—}420], [DV25DATA_{—}420], [DV50_{—}422], [DV50DATA_{—}422], [IMX30], [IMX40], [IMX50], [MPEG2HD25_{—}1280_MP@HL], [MPEG2HD25_{—}1440_MP@HL], [MPEG2HD50_{—}1280 MP@HL][MPEG2HD50_{—}1440_MP@HL], [MPEG2HD50_{—}1920_MP@HL], [MPEG2HD50_{—}1280_{—}422PMP@HL], and [MPEG2HD50_{—}1920_{—}422PMP@HL].

[DV25_{—}411], [DV25DATA_{—}411][DV25_{—}420], and [DV25DATA 420] belong to a group that is based on the DV standard and that has a bit rate of 25 Mbps.

[DV50_{—}422] and [DV50DATA_{—}422] belong to a group that is based on the DV standard and that has a bit rate of 30 Mbps.

[IMX30], [IMX40], and [IMX50] belong to a group of which pictures are composed of only I pictures of MPEG. The bit rate of [IMX30] is 30 Mbps. The bit rate of [!MX40] is 40 Mbps. The bit rate of [IMX50] is 50 Mbps.

[MPEG2HD25_{—}1280_MP@HL), [MPEG2HD25_{—}1440_MP@HL], [MPEG2HD50_{—}1280 MP@HL], (MPEG2HD50_{—}1440 MP@HL], [MPEG2HD50_{—}1920_MP@HL], [MPEG2HD50_{—}1280_{—}422PMP@HL], and [MPEG2HD50_{—}1920_{—}422PMP@HL] belong to a group of Long GOP of MPEG.

When all the plurality of types of encoding systems identified at step S102 belong to the group that is based on the DV standard and that has a bit rate of 25 Mbps (for example, the types of the encoding systems identified at step S102 are [DV25_{—}411] and [DV25_{—}420]), the edit list file management section 63 generates an edit list file that contains an expression of a group name that includes [DV25_{—}411] and [DV25_{—}420].

When the plurality of types of encoding systems identified at step S102 belong to a group that is based on the DV standard and that has bit rates of 25 Mbps and 50 Mbps (for example, the types of the encoding systems identified at step S102 are [DV25_{—}411] and [DV50_{—}422]), the edit list file management section 63 generates an edit list file that contains an expression of group name [DV50] that includes [DV25_{—}411] and [DV50_{—}422]. In other words, group name [DV50] includes not only a group that is based on the DV standard and that has a bit rate of 50 Mbps, but a group that is based on the DV standard and that has a bit rate of 25 Mbps.

When all the types of encoding systems identified at step S102 belong to a group of IMX (for example, the types of encoding systems identified at step S102 are [IMX40] and [IMX50]), the edit list file management section 63 generates an edit list file that contains an expression of group name [IMX] that includes [IMX40] and [IMX50].

When all the plurality of types of encoding systems identified at step S102 belong to a group of Long GOP of MPEG (for example, the types of encoding systems identified at step S102 are [MPEG2HD25_{—}1280_MP@HL], [MPEG2HD25_{—}1440_MP@HL], and [MPEG2HD50_{—}1440_MP@HL], the edit list file management section 63 generates an edit list file that contains an expression of group name [MPEG] that includes [MPEG2HD25_{—}1280_MP@HL], [MPEG2HD25_{—}1440 MP@HL], and [MPEG2HD50_{—}1440_MP@HL].

When the plurality of types of encoding systems identified at step S102 belong to a group that is based on the DV standard and that has a bit rate of 25 Mbps and a group of IMX (for example, the types of encoding systems identified at step S102 are [DV25_{—}411] and [DV25_{—}420]; and [IMX40] and [IMX50]), the edit list file management section 63 generates an edit list file that contains an expression of group name [DV25+IMX] that includes [DV25_{—}411] and [DV25_{—}420]; and [IMX40] and [IMX50].

When the plurality of types of encoding systems identified at step S102 belong to a group that is based on the DV standard and that has bit rates of 25 Mbps and 50 Mbps and a group of IMX (for example, the types of encoding systems identified at step S102 are [DV25_{—}411], [DV25_{—}420], and [DV50_{—}422]; and [IMX40] and [IMX50]), the edit list file management section 63 generates an edit list file that contains an expression of group name [DV50+IMX] that includes (DV25_{—}411], [DV25_{—}420], and [DV25_{—}422]; and [IMX40] and [IMX50].

Thereafter, the flow advances to step S106.

At step S106, the edit list generation section 61 generates a file (other than an edit list file) managed under the edit list directory 301 generated at step S101. The edit list generation section 61 generates an edit list clip meta data file that is a file that contains clip meta data newly generated according to clip meta data.

FIG. 17 shows an example of an edit list file 311 recorded under the edit list directory 301 by the process at step S104 or step S105 and an edit list clip meta data file 312 recorded under the edit list directory 301 by the process at step S106.

In FIG. 17, under the edit list directory 301, the edit list file (E0002E01.SMI) 311 that is a file that manages the edited result (edit list) and the edit list clip meta data file (E0002M01.XML) 312 that is a file that contains clip meta data corresponding to essence data that has been edited (a portion extracted as edited data from essence data of all clips that have been edited) or clip meta data that have been newly generated according to the clip meta data extracted as the edited result.

The edit list clip meta data file 312 is a file that contains clip meta data that have been newly generated according to clip meta data (a clip meta data file placed under the clip root directory 208) of a clip that has been edited. When a clip is edited, a portion corresponding to essence data that have been edited is extracted from clip meta data contained in the clip meta data file 228 shown in FIG. 6. With the extracted portion, new clip meta data are generated so that edited essence data become one clip. The new clip meta data are managed as an edit list clip meta data file. In other words, new clip meta data are added to essence data that have been edited so that edited essence data become one clip. The clip meta data are managed as one edit list clip meta data file. Thus, an edit list clip meta data file is generated whenever a clip is edited.

To allow the edit list clip meta data file 312 to have versatility, it is written in the XML.

After step S106, the flow advances to step S107. At step S107, the index file management section 18 adds an edit list element corresponding to a file managed under the edit list directory 301 to the edit list table of the index file 41 to update the recorded contents of the index file 41.

At step S108, the index file management section 18 records the index file 41 to which the edit list element has been added at step S107 under the PROAV directory 202 on the optical disc 30 through the drive 29. At this point, the index file 204 recorded under the PROAV directory 202 is deleted. The index file management section 18 generates a backup file of the index file 41 to which the edit list element has been added at step S107 and records the backup file under the PROAV directory 202 on the optical disc 30 through the drive 29. At this point, the backup file 205 recorded under the PROAV directory 202 is deleted.

In such as manner, the edit process is executed.

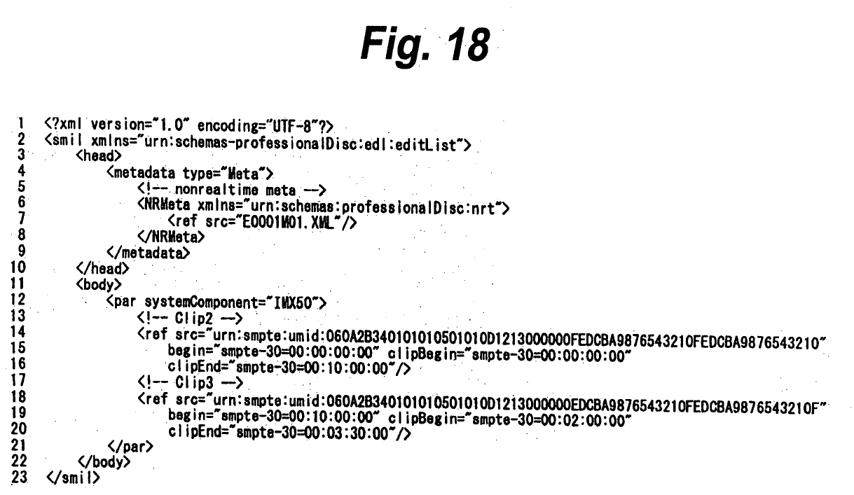

FIG. 18 to FIG. 27 show an example of a script of the edit list file 311 generated by the process at step S104 or step S105 and an example of a script of the index file 41 generated by the process at step S107.

FIG. 18 shows an example of a script of the edit list file 311 generated by the process at step S104. FIG. 18 shows the case of which the types of encoding systems of two clips managed under the clip directory 212 and the clip directory 213 are the same encoding system [IMX50].

In [<?xml version=“1.0” encoding=“UTF-8”?>], line 1, FIG. 18, [xml version=“1.0”] represents that the edit list file 311 is an XML document. [encoding=“UTF-8”] represents that the character code is UTF-8, fixed. [<smil xmlns=“urn:schemas-professionalDisc:ed1:editList”>], line 2, FIG. 8, represents a name space of the XML document. [<head>], line 3, FIG. 18, represents that a header starts from line 4. In other words, the edit list file 311 is composed of a header portion and a body portion. The header is followed by the body. The header ends in line 10, FIG. 18.

[<body>], line 11, FIG. 18, represents that the body portion starts from line 12. In [par systemComponent=“IMX50”], line 12, FIG. 18, [par] corresponds to [</par>], line 21. [par] represents that clips written from line 13 to line 20 are reproduced in parallel. [systemComponent=!IMX50.] represents the encoding system of a video file of a clip that was used when the edit list file 311 was edited. In this example, this expression represents that all the types of encoding systems of video files of clips that were used when the edit list file 311 was edited are [IMX50].

[<!--Clip2-->], line 13, FIG. 18, represents that files of clip 2, namely files managed under the clip directory 212 that was generated as the second clip, are reproduced. In [<ref src=“urn: samte:umid:060A2B340101010501010D1213000000FEDCBA 9876543210FEDCBA9876543210” begin=“smpte-30=00:00:00:00” clipBegin=“smpte-30=00:00:00:00” clipEnd=“smpte-30=00:00:00:00”/>], line 14 to 16, FIG. 18, [src=“urn:samte:umid:060A2B340101010501010D1213 000000FEDCBA9876543210FEDCBA9876543210”] represents a name space that identifies the clip directory 212. In particular, [src=“urn:samte:umid:060A2B340101010501 010D1213000000FEDCBA9876543210FEDCBA9876543210”] represents the UMID of the clip directory 212. In this example, this expression represents that the UMID of the clip directory 212 is [060A2B340101010501010D12 13000000FEDCBA9876543210FEDCBA9876543210]. [begin=“smpte-30=00:00:00:00”] represents a time code in the edited result at which the reproduction for the video file managed under the clip directory 212 is started. [clipBegin=“smpte-30=00:00:00:00”] represents a time code in the video file at which the reproduction for the video file managed under the clip directory 212 is started. [clipEnd=“smpte-30=00:10:00:00”] represents a time code in the video file at which the reproduction for the video file managed under the clip directory 212 is ended.

<!--Clip3-->], line 17, FIG. 18, represents that files of clip 3, namely files managed under the clip directory 213 that was generated as the third clip, are reproduced. In [<ref src=“urn: samte:umid:060A2B340101010501010D1213000000FEDCBA 9876543210FEDCBA9876543210F” begin=“smpte-30=00:10:00:00” clipBegin=“smpte-30=00:02:00:00” clipEnd=“smpte-30=00:03:30:00”>], line 18 to 20, FIG. 18, (src=“urn:samte:umid:060A2B340101010501010D1213 000000FEDCBA9876543210FEDCBA9876543210F”] represents a name space that identifies the clip directory 213. In particular, [src=“urn:samte:umid:060A2B340101010501 010D1213000000FEDCBA9876543210FEDCBA9876543210F”] represents the UMID of the clip directory 213. In this example, this expression represents that the UMID of the clip directory 213 is [060A2B340101010501010D12 13000000FEDCBA9876543210FEDCBA9876543210F]. [begin=“smpte-30=00:10:00:00”] represents a time code in the edited result at which the reproduction for the video file managed under the clip directory 213 is started. [clipBegin=“smpte-30=00:02:00:00”] represents a time code in the video file at which the reproduction for the video file managed under the clip directory 212 is started. [clipEnd=“smpte-30=00:03:30:00”] represents a time code in the video file at which the reproduction for the video file managed under the clip directory 212 is ended.

[</par>], line 21, FIG. 18, corresponds to ([par], line 12. As described above, this expression represents that the video file managed under the clip directory 212 and the video file managed under the clip directory 213 are reproduced in parallel.

[</body>], line 22, FIG. 18, represents that the body portion that starts from line 11 ends.

[/smil>], line 23, FIG. 18, represents that smil that starts from line 2 ends.

As described above, the edit list file 311 contains an expression (line 12, FIG. 18) of encoding systems of video files contained in clips that have been edited so that they are connected and successively reproduced. Thus, with reference to the edit list file 311, the types of encoding systems of video files contained in clips that have been edited can be identified without need to reference the clip information file of each clip.

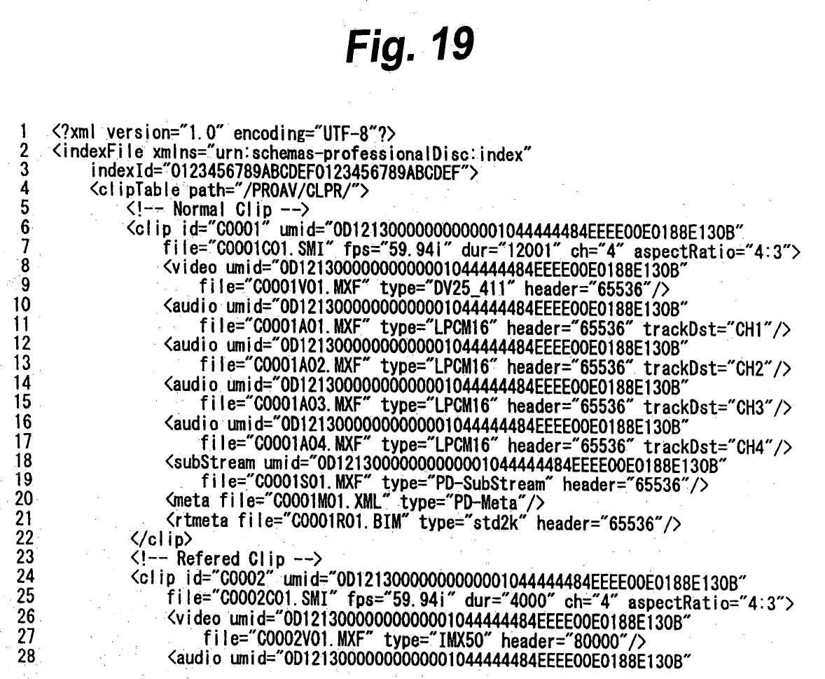

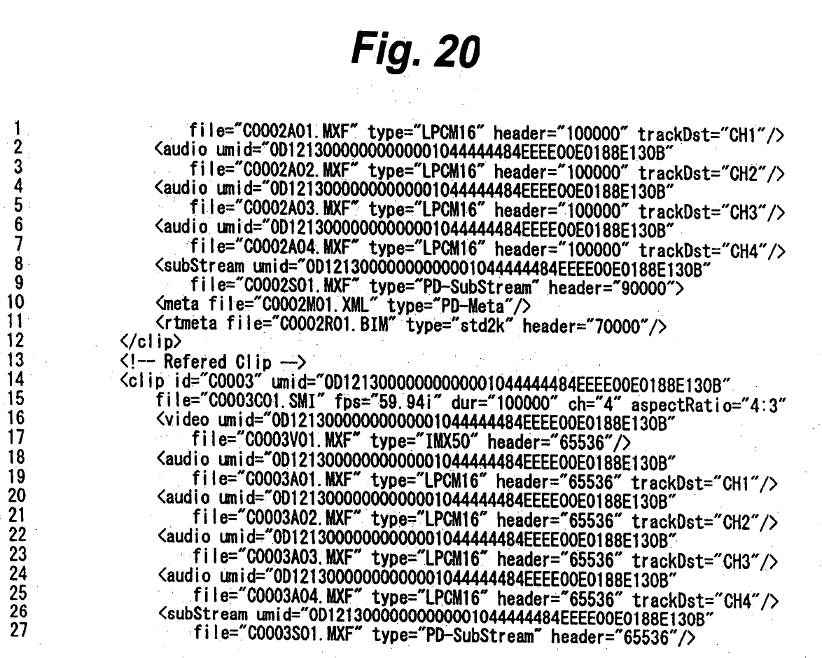

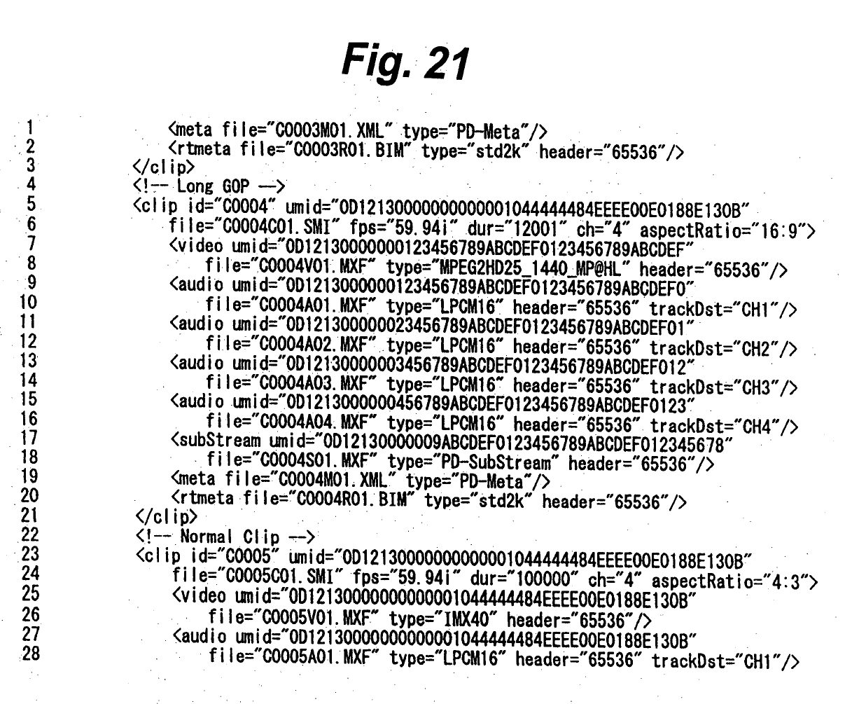

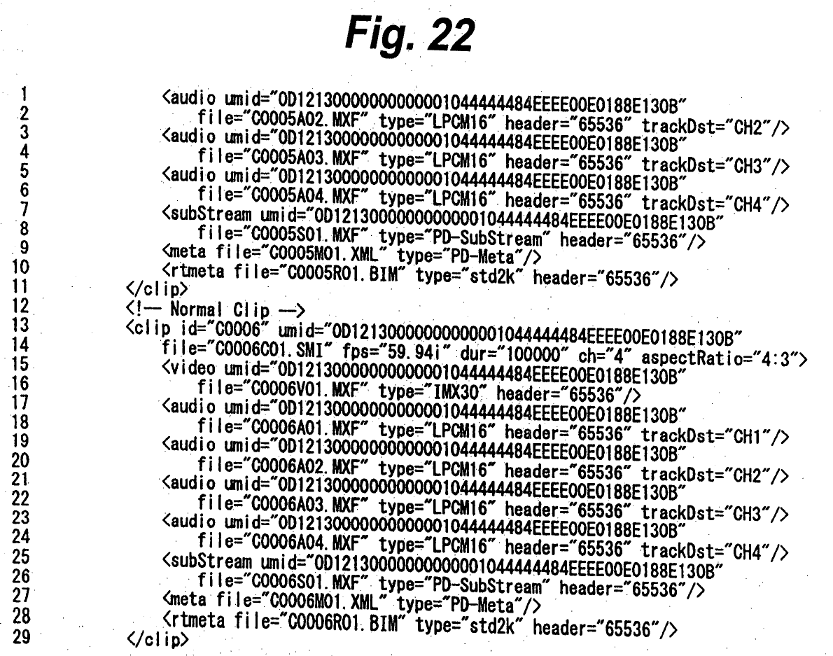

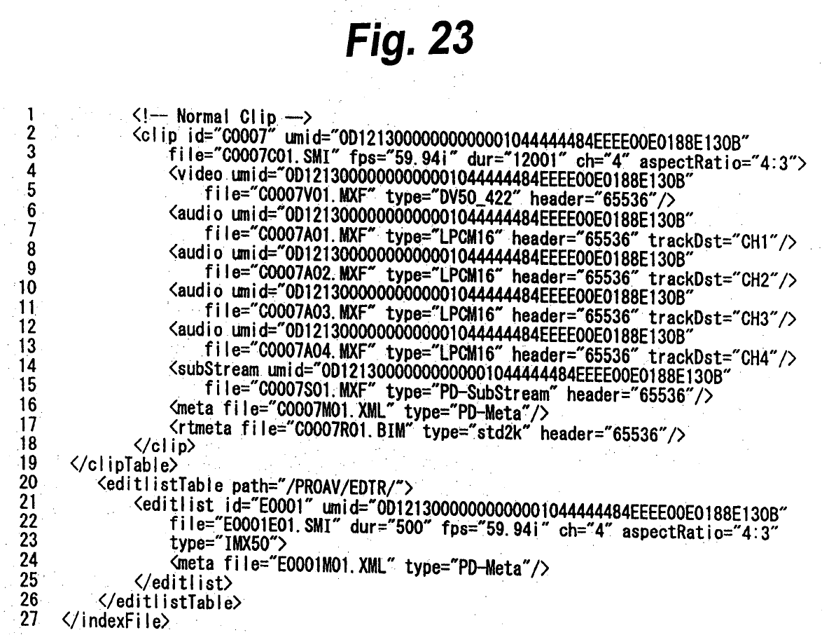

FIG. 19 to FIG. 23 show an example of a script of the index file 41 to which an edit list element was added by the process at step S107 when the edit list file 311 shown in FIG. 18 was generated. FIG. 20 shows a part of the script preceded by FIG. 19. FIG. 21 shows a part of the script preceded by FIG. 20. FIG. 22 shows a part of the script preceded by FIG. 21. FIG. 23 shows a part of the script preceded by FIG. 22.

Since the expressions from line 1, FIG. 19 to line 19, FIG. 23 are the same as those from line 1, FIG. 7 to line 19, FIG. 11, their explanation will omitted.

Attributes of an edit list managed under the edit list directory 301 are additionally written from [<editlistTable path=“/PROAV/EDTR/”>], line 20 to [</editlistTable>], line 25.

In [<editlist id=“E0001” umid=“0D12130000000000001044444484EEEE00E0188E130B” file=“E0001E01.SMI” dur=“500” fps=“59.94i” ch=“4” aspectRatio=“4:3” type=“IMX50.”>], line 21 and line 22, FIG. 23, [id=“E0001”] represents the ID of the edit list. In this example, this expression represents [E0001] as the ID of the edit list. This ID is the same as the directory name of the edit list directory 301. [umid=“0D12130000000000001044444484EEEE00E0188 E130B”] represents the UMID of the edit list managed under the edit list directory 301. In this example, this expression represents [0D121300000000000010 44444484EEEE00E0188E130B] as the UMID. In addition, [file=“E0001E01.SMI”) represents the file name of the edit list file 311 managed under the edit list directory 301. In this example, this expression represents [E0001E01.SMI] as the file name. [dur=“500”] represents a duration for the reproduction according to the edit list managed under the edit list directory 301 in the unit of frames. In this example, this expression represents that the duration for the reproduction according to the edit list managed under the edit list directory 301 is 500 frames. [fps=“59.94i”] represents the resolution in the time base direction in the case that the reproduction is performed according to the edit list managed under the edit list directory 301 in the unit of fields/sec. In this example, this expression represents the signal frequency according to the NTSC system. [ch=“4”] represents the number of audio channels in the case that the reproduction is performed according to the edit list managed under the edit list directory 301. In this example, this expression represents that the number of audio channels is four. [aspectRatio=“4:3”] represents the aspect ratio of a video file that is reproduced according to the edit list managed under the edit list directory 301. In this example, this expression represents that the aspect ratio is 4:3. [type=“IMX50”] represents the encoding system of the video file reproduced with reference to the edit list file 311. In this example, this expression represents [IMX50] as the encoding system.

[<meta file=“E0001M01.XML” type=“PD-Meta”/>], line 23, FIG. 23, represents an attribute of the edit list clip meta data file 312. This meta element manages information about the edit list clip meta data file 312. [file=“E0001M01.XML”] represents the file name of the edit list clip meta data file 312. In this example, this expression represents [E0001M01.XML] as the file name of the edit list clip meta data file 312. [type=“PD-Meta”] represents the file format of the edit list clip meta data file 312. According to this embodiment, this expression represents [PD-Meta] as the file format of the edit list clip meta data file 312.

[</editlist>], line 25, FIG. 23, represents that information about the attributes of the edit list managed under the edit list directory 301 ends. In other words, attributes of the edit list managed under the edit list directory 301 are written from line 21 to line 25, FIG. 23.

In other words, the expressions from line 21 to line 25, FIG. 23, are additionally written as an edit list element to the index file 41 by the process at step S107.

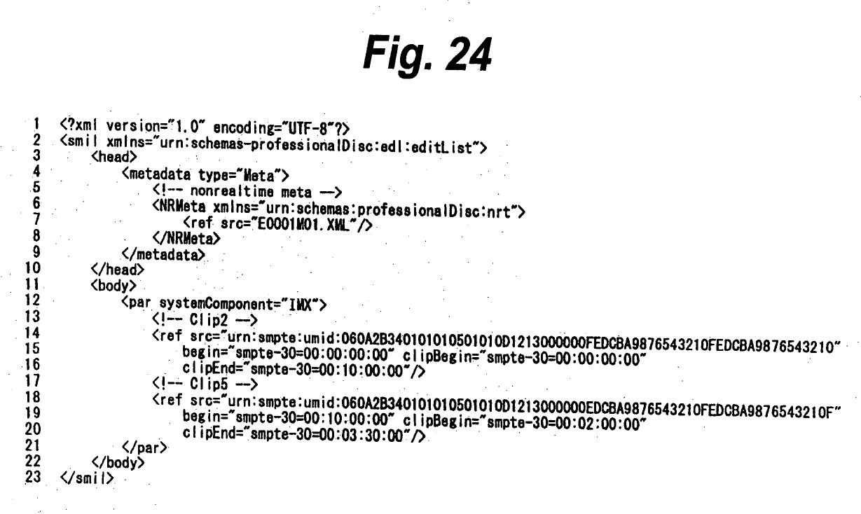

FIG. 24 shows an example of a script of the edit list file 311 generated by the process at step S105. FIG. 24 shows an example of which a video file (encoded according to IMX50 as an encoding system) managed under the clip directory 212 and a video file (encoded according to IMX40 as an encoding system) managed under the clip directory 215 were connected as an edit process.

[IMX] as the group name of a group that includes IMX50 and IMX40 is written in line 12, FIG. 24. In other words, (<par systemComponent=“IMX”>] is written in line 12. In this expression, [systemComponent=“IMX”] represents the encoding systems of the video files managed under the clip directory 212 and the clip directory 215. In this example, this expression represents [IMX] as the encoding systems of the video files. [IMX] represents a group name of a group that includes IMX50 and IMX40.

[<!--Clip-->] is written in line 13, FIG. 24. [<!--Clip5-->] is written in line 17. These expressions represent the clip directory 212 and the clip directory 215. In other words, attributes of the file managed under the clip directory 212 are written from line 13 to line 16. Attributes of the file managed under the clip directory 215 are written from line 17 to line 20.

Since the other expressions of the script shown in FIG. 24 are the same as those of the script shown in FIG. 18, their description will be omitted.

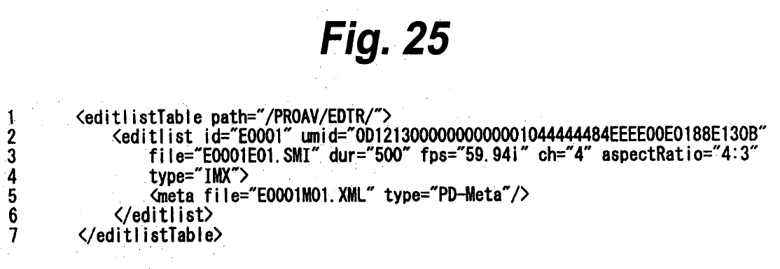

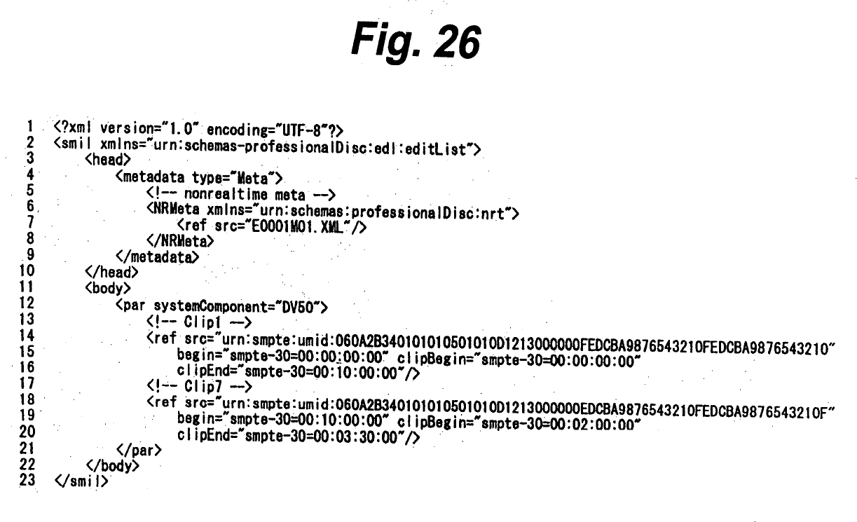

FIG. 25 shows an example of a part of a script of the index file 41 to which an edit list element was added by the process at step S107 when the edit list file 311 shown in FIG. 24 was generated. In other words, FIG. 19 to FIG. 23 show an example of a script of the index file 41. However, when the edit list file 311 shown in FIG. 24 is generated, the index file 41 of which expressions from line 20 to line 26 shown in FIG. 23 of the script shown in FIG. 19 to FIG. 23 are replaced with expressions from line 1 to 7 shown in FIG. 25 is generated.

A group name that is the same as that shown in FIG. 24 is written in line 4, FIG. 25. In other words, [type=“IMX”] is written in line 4, FIG. 25. This expression corresponds to [systemComponent=“IMX”], line 12, FIG. 24.

Since the other expressions of the script shown in FIG. 25 are the same as the expressions from line 20 to 26 shown in FIG. 23, their description will be omitted.

FIG. 26 shows an example of a script of the edit list file 311 generated by the process at step S105. FIG. 26 shows an example of the case that a video file (encoded according to DV25_{—}411 as an encoding system) managed under the clip directory 211 and a video file (encoded according to DV50_{—}422 as an encoding system) managed under the clip directory 217 were connected as an edit process.

[DV50] as the group name of a group that includes DV25_{—}411 and DV_{—}422 is written in line 12, FIG. 26. In other words, [<par systemComponent=“DV50”>] is written in line 12. In this expression, [systemComponent=“DV50”] represents an encoding system of the video files managed under the clip directory 211 and the clip directory 217. In this example, this expression represents [DV50] as the encoding system of the video files. [DV50] represents a group name of a group that includes DV25_{—}411 and DV50_{—}422.

[<!--Clip1-->] is written in line 13, FIG. 26. [<!--Clip7-->] is written in line 17. These expressions represent the clip directory 211 and the clip directory 217. In other words, attributes of the file managed under the clip directory 211 are written from line 13 to line 16. Attributes of the file managed under the clip directory 217 are written from line 17 to line 20.

Since the other expressions of the script shown in FIG. 26 are the same as those of the script shown in FIG. 18, their description will be omitted.

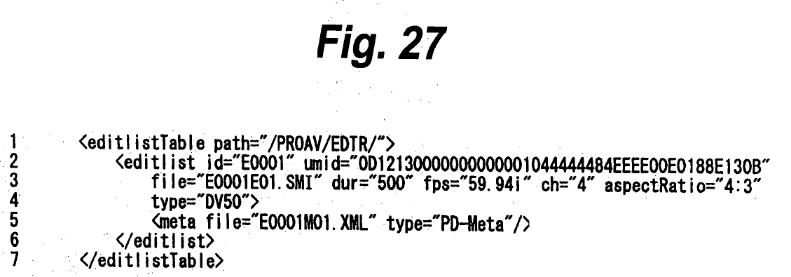

FIG. 27 shows an example of a part of a script of the index file 41, to which an edit list element was added by the process at step S107 when the edit list file 311 shown in FIG. 26 was generated. In other words, FIG. 19 to FIG. 23 show an example of the script of the index file 41. When the edit list file 311 shown in FIG. 26 is generated, the index file 41 of which the expressions from line 20 to line 26 shown in FIG. 23 of the script shown in FIG. 19 to FIG. 23 are replaced with expressions from line 1 to line 7 shown in FIG. 27 is generated.

A group name that is the same as that shown in FIG. 26 is written in line 4, FIG. 27. In other words, [type=“DV50”] is written in line 4, FIG. 25. This expression corresponds to [systemComponent=“DV50”], line 12, FIG. 26.

Since the other expressions of the script shown in FIG. 27 are the same as the expressions from line 20 to line 26 shown in FIG. 23, their description will be omitted.

As exemplified above, the record and reproduction apparatus 1 according to the present invention writes encoding systems of video files to be reproduced according to the edit list file 311 to the edit list file 311. Thus, with reference to encoding systems written in the edit list file 311, the reproduction apparatus that performs the reproduction process according to the edit list file 311 can easily determine whether the apparatus can decode the video files contained in the edit list file 311.

In addition, when encoding systems for a plurality of video files written in an edit list are different and these encoding systems belong to the same group (for example, [DV25], [DV50], [IMX], or [MPEG]), the record and reproduction apparatus 1 according to the present invention writs the group name in the edit list file 311. Thus, the reproduction apparatus that performs the reproduction process according to the edit list file 311 can determine whether the apparatus can decode the video files for each group rather than each encoding system. Thus, the apparatus can easily determine whether it can reproduce each video file.

In addition, as described above, since encoding systems for clips written in an edit list can be also recorded in the index file, the apparatus can determine whether it can reproduce the edit list with reference to the index file.

Next, with reference to a flow chart shown in FIG. 28, a reproduction process according to the edit list file 311 will be described. It is assumed that the optical disc 30 has been unloaded from the record and reproduction apparatus 1 shown in FIG. 1, loaded into the record and reproduction apparatus 101 shown in FIG. 3, and the record and reproduction apparatus 101 shown in FIG. 3 executes a reproduction process. The index file 141 stored in the index file management section 118 of the record and reproduction apparatus 101 shown in FIG. 3 has been read from the optical disc 30 at timing of which the optical disc 30 has been loaded into the drive 129.

When the user operates the operation section 121 and issues a command that causes a reproduction according to the edit list file 311 to be executed, the flow advances to step S201 shown in FIG. 28. At step S201, the index file management section 118 selects a portion that represents an edit list element of the edit list to be reproduced according to the command from the index file 141. For example, the expressions from line 21 to line 25 shown in FIG. 23, the expressions from line 2 to line 6 shown in FIG. 25, or the expressions from line 2 to line 6 shown in FIG. 27 are selected by the process at step S201.

At step S202, the encoding system obtainment section 162 of the reproduction control section 116 obtains a portion that represents encoding systems from the expressions selected at step S201. When the index file management section 118 has selected the expressions from line 21 to line 25 shown in FIG. 23 by the process at step S201, the encoding system obtainment section 162 obtains [type=“IMX50”], 23, FIG. 23. When the index file management section 118 has selected the expressions from line 2 to line 6 shown in FIG. 25 by the process at step S201, the encoding system obtainment section 162 obtains [type=“IMX”], line 4, FIG. 24. On the other hand, when the index file management section 118 has selected the expressions from line 2 to line 6 shown in FIG. 27 by the process at step S201, the encoding system obtainment section 162 obtains [type=“DV50], line 4, FIG. 27.

The reproduction control section 116 has stored a list of encoding systems with which the decoders of the record and reproduction apparatus 101 can deal (hereinafter this list is also referred to as an encoding system list). At step S203, the reproduction possibility determination section 163 determines whether all encoding systems obtained at step S202 have been recorded in the encoding system list. As a result, the reproduction possibility determination section 163 can determine whether the record and reproduction apparatus 101 has all decoders that reproduces the edit list file 311. When the determined result represents that the record and reproduction apparatus 101 does not have all decoders that reproduce the edit list file 311 (the record and reproduction apparatus 101 lacks for at least one decoder that reproduces the edit list file 311), the flow advances to step S204.

At step S204, the reproduction possibility determination section 163 informs the CPU 111 that the record and reproduction apparatus 101 cannot perform a reproduction according to the edit list file 311. When the CPU 111 receives the information, the CPU 111 causes the display section 122 to display a message (error screen) that represents that the reproduction according to the edit list file 311 is impossible.

When the reproduction possibility determination section 163 has determined at step S203 that the record and reproduction apparatus 101 has all decoders that decode the edit list file 311, the flow advances to step S205.

At step S205, the reproduction possibility determination section 163 informs the reproduction execution section 164 that the reproduction according to the edit list file 311 is possible. When the reproduction execution section 164 receives the information, the reproduction execution section 164 executes the reproduction for video files and so forth according to the script of the edit list file 311. In other words, the reproduction execution section 164 reads video files and so forth from the optical disc 30 through the drive 129, decodes them, causes the display section 122 to display them, and performs other processes.

In the foregoing manner, a reproduction process according to the edit list is performed.

In the foregoing reproduction process, the case of which expressions of encoding systems recorded in the index file 141 are referenced was described. Of course, with reference to expressions of the edit list file 311 instead of the index file 141, encoding systems may be identified.

In the foregoing description, when one edit list contains a plurality of encoding systems, a group name thereof is written in an edit list. Instead, a plurality of encoding systems contained in an edit list may be written in an edit list file.

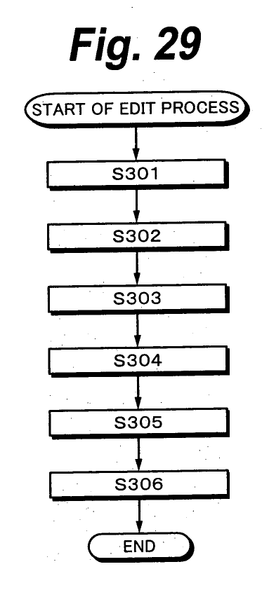

Next, with reference to a flow chart shown in FIG. 29, an edit process that writes all of a plurality of encoding systems contained in an edit list to an edit list file will be described.

Since processes at step S301 and step S302 shown in FIG. 29 are the same as those at step S101 and step S102 shown in FIG. 15, their description will be omitted. At step S303 shown in FIG. 29, the edit list file management section 63 generates an edit list file that lists all of the plurality of encoding systems identified at step. S302 and records the edit list file under the edit list directory 301 on the optical disc 30 through the drive 29. Thereafter, the flow advances to step S304.

Since processes from step S304 to step S306 are the same as those from step S106 to step S108 shown in FIG. 15, their description will be omitted.

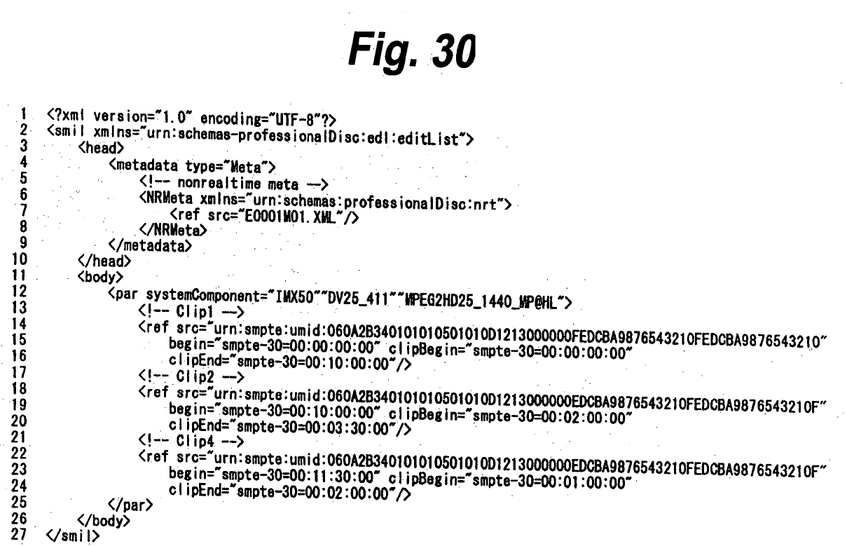

FIG. 30 shows an example of a script of the edit list file generated at step S303. FIG. 30 shows an example of the case of which a video file (encoded according to DV25_{—}411 as an encoding system) managed under the clip directory 211, a video file (encoded according to IMX50 as an encoding system) managed under the clip directory 212, and a video file (encoded according to MPEG2HD25_{—}1440_MP@HL as an encoding system) managed under the clip directory 214 have been are connected as an edit process.

IMX50, DV25_{—}411, and MPEG2HD25_{—}1440_MP@HL are written in line 12 shown in FIG. 30. In other words, [<par systemComponent “IMX50” “DV25_{—}411”“MPEG2HD25_{—}1440 MP@HL”>] is written in line 12. In this expression, [systemComponent=“IMX50” DV25_{—}411”“MPEG2HD25_{—}1440 MP@HL”] represents encoding systems for video files managed under the clip directory 211, the clip directory 212, and the clip directory 214. In this manner, all encoding systems for clips may be listed in an edit list file.

[<!--Clip1-->] is written in line 13, FIG. 20. [<!--Clip2-->] is written in line 17. [<!--Clip4-->] is written in line 21. These expressions represent the clip directory 211, the clip directory 212, and the clip directory 214. In other words, attributes of a file managed under the clip directory 211 are written from line 13 to line 16. Attributes of a file managed under the clip directory 212 are written from line 17 to line 20. Attributes of a file managed under the clip directory 214 are written from line 21 to line 24.

Since the other expressions of the script shown in FIG. 30 are the same as those of the script shown in FIG. 18, their description will be omitted.

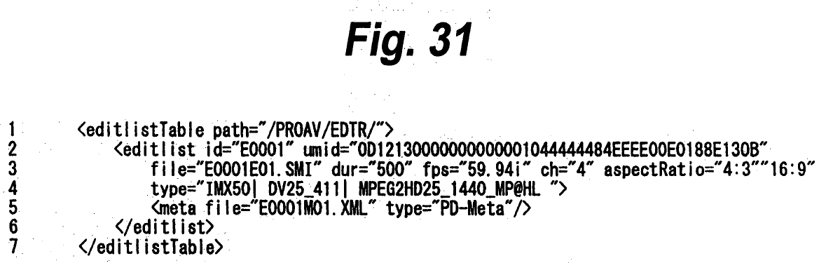

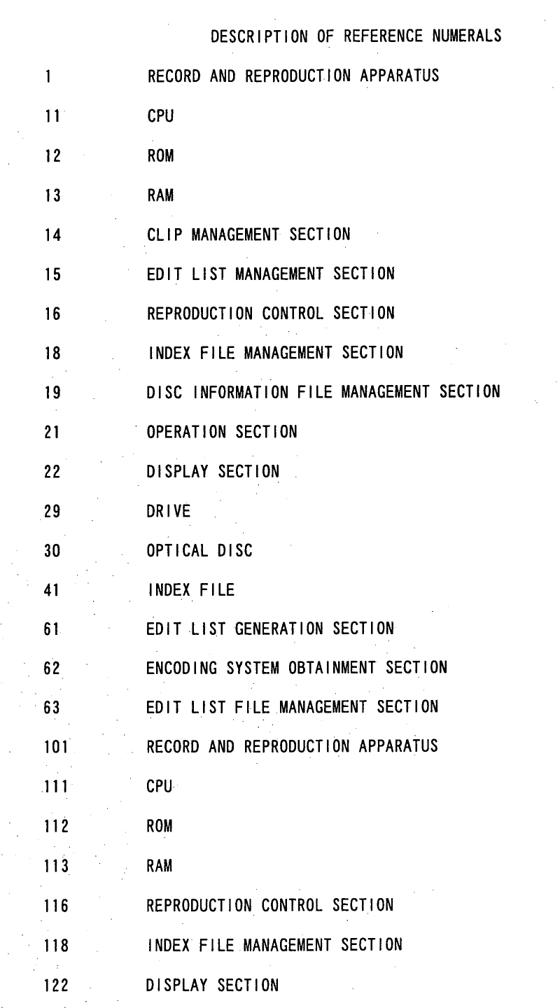

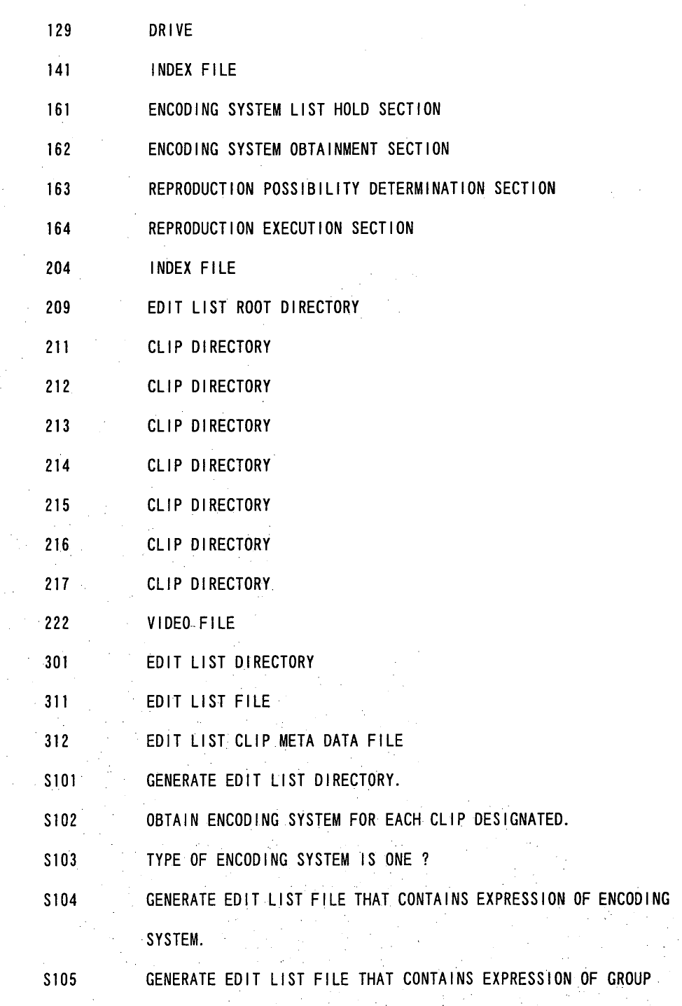

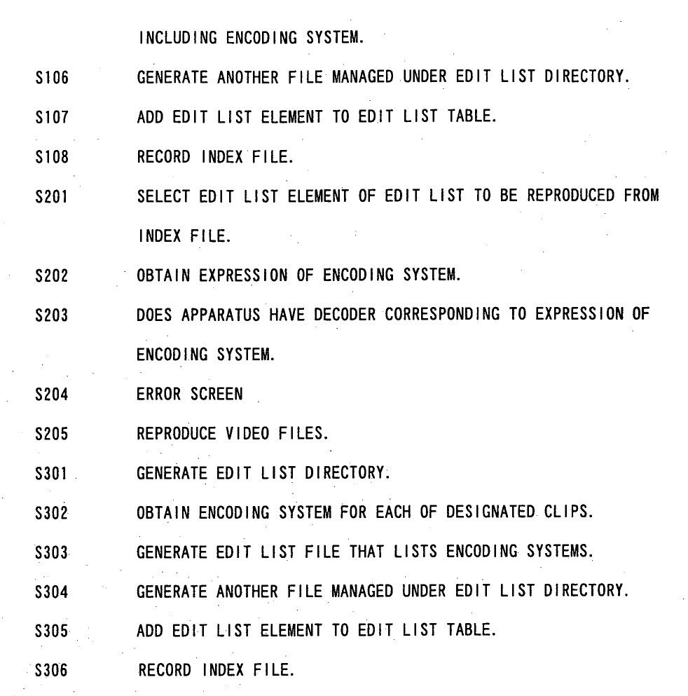

FIG. 31 shows a part of the script of the index file 41 to which an edit list element was added by the process at step S305 when the edit list file 311 shown in FIG. 30 was generated. In other words, FIG. 19 to FIG. 23 show an example of the script of the index file 41. However, when the edit list file 311 shown in FIG. 30 is generated, the index file 41 of which the expressions from line 20 to line 26 shown in FIG. 23 of the script shown in FIG. 19 to FIG. 23, are replaced with expressions from line 1 to line 7 shown in FIG. 31 is generated.

A group name that is the same as that shown in FIG. 30 is written in line 4, FIG. 31. In other words, [type=“IMX50|DV25_{—}411|MPEG2HD25_{—}1440_MP@HL”] is written in line 4, FIG. 31. This expression corresponds to [systemComponent=“IMX50” “DV25_{—}411”“MPEG2HD25_{—}1440_MP@HL”], line 25, FIG. 30.

Since the other expressions of the script shown in FIG. 31 are the same as those of line 20 to line 26 of FIG. 23, their description will be omitted.

As described above, according to the present invention, with reference to only an edit list file (or an index file) that manages an edited result, the reproduction apparatus (for example, the record and reproduction apparatus 101 shown in FIG. 3) that reproduces data that have been edited can identify decoders necessary to decode edited data. Thus, the reproduction apparatus can easily determine whether the apparatus can reproduce the edited result.

In other words, in the past, since information about encoding systems of data that were edited was not recorded in both an edit list file and an index file, a conventional reproduction apparatus that reproduces the edit list needed to read a clip information file of a clip directory that manages a clip (video file) written in the edit list and identify an encoding system of the clip. Thus, if many clips were written in a clip list, the apparatus needed to read a clip information file of each clip directory that manages each of many clips and identify an encoding system of each clip to determine whether the apparatus could reproduce the edit list. Thus, the conventional apparatus could not easily determine whether it could reproduce the edit list.

In contrast, according to the present invention, since an edit list file contains information about an encoding system of a clip (video file), even if an edit list contains information about many clips, with reference to only the edit list file, the apparatus can identify encoding systems of these clips and easily determine whether the apparatus can reproduce the edit list.

The foregoing description can be applied to other than the foregoing encoding systems. In the foregoing description, the case of which information about encoding systems of video files is written was exemplified. Of course, information about encoding systems of other than video files (for example, audio files, low resolution files, and so forth) may be written in the same manner.

In the foregoing, the case of which data such as moving picture data, audio data, low resolution data, frame meta data, clip meta data, and edit lists are recorded on an optical disc was described. The record medium on which these types of data are recorded is not limited to an optical disc. Instead, the record medium may be for example an optical magnetic disc, a magnetic disc such as a flexible disc or a hard disk, a magnetic tape, or a semiconductor memory such as a flash memory.

In the foregoing, the case of which the record and reproduction apparatus 1 performs an edit process and the record and reproduction apparatus 101 performs a reproduction process was described. An information process apparatus that performs an edit process and a reproduction process may be an information process apparatus dedicated for an edit process. Instead, the information process apparatus may be of another type.

In the foregoing, record and reproduction apparatuses were exemplified. The apparatuses are not limited to single apparatuses. Instead, each of these apparatuses may be separated into a record apparatus and a reproduction apparatus. For example, the record apparatus may execute an edit process, while the reproduction apparatus may execute a reproduction process.

The foregoing sequence of processes can be executed by hardware or software. When a sequence of processes are executed by software, a program that composes the software is installed in dedicated hardware of a computer. Instead, the software is installed form a record medium or the like in for example a general-purpose personal computer that executes various functions installed as various programs.

As shown in FIG. 1 and FIG. 3, the record medium may be unaccompanied by the main body of the record and reproduction apparatus 1 or the record and reproduction apparatus 101 and delivered to the user to provide the program. In this case, the record medium on which the program has been recorded may be a magnetic disc (including a flexible disc), an optical disc (including CD-ROM (Compact Disc-Read Only Memory) and DVD (Digital Versatile Disc)), an optical-magnetic disc (including MD (Mini-Disc)), the removable medium 28 or 128 including a package medium composed of a semiconductor memory or the like. Instead, the record medium may be, pre-installed in the main body of the computer. In this case, the record medium on which the program has been recorded may be the ROM 12 or 112 or a hard disk included in the storage section 25 or 125.

In this specification, steps that write a program provided by a medium are executed sequentially in the order of which they are written. Instead, the steps may be executed in parallel or discretely.

In this specification, the system represents a whole apparatus composed of a plurality of devices.

As described above, according to the present invention, video data, audio data, and so forth can be edited. In particular, according to the present invention, it can be easily determined whether moving picture data and audio data edited and recorded on a record medium can be reproduced.

1.-8. (canceled)

9. An information process apparatus that processes a plurality of pieces of data recorded on a record medium, comprising:
identification means for identifying encoding systems for the plurality of pieces of data in an edit for which they are connected and successively reproduced;
generation means for generating one management information file that manages the result of the edit so that the management information file contains a group name to which all the encoding systems identified by the identification means belong and recording the management information file in a directory of the record medium attachable and detachable to and from the information process apparatus, the directory for the management information file being different from other directories of the record medium; and
determination means for reading the management information file generated by the generation means and recorded on the record medium and determining whether all the plurality of pieces of data can be reproduced according to the group name contained in the management information file when the plurality of pieces of data are reproduced as the result of the edit.

10. An information process method for an information process apparatus that processes a plurality of pieces of data recorded on a record medium, comprising the steps of:
identifying encoding systems for the plurality of pieces of data in an edit for which they are connected and successively reproduced;
generating one management information file that manages the result of the edit so that the management information file contains a group name to which all the encoding systems identified at the identification step belong and recording the management information file in a directory of the record medium attachable and detachable to and from the information process apparatus, the directory for the management information file being different from other directories of the record medium; and
reading the management information file generated at the generation step and recorded on the record medium and determining whether all the plurality of pieces of data can be reproduced according to the group name contained in the management information file when the plurality of pieces of data are reproduced as the result of the edit.

11. A record medium on which a program has been recorded, the program being readable by a computer, the program being used for an information process apparatus that processes a plurality of pieces of data recorded on a record medium, the program comprising the steps of:
identifying encoding systems for the plurality of pieces of data in an edit for which they are connected and successively reproduced;
generating one management information file that manages the result of the edit so that the management information file contains a group name to which all the encoding systems identified at the identification step belong and recording the management information file in a directory of the record medium attachable and detachable to and from the information process apparatus, the directory for the management information file being different from other directories of the record medium; and
reading the management information file generated at the generation step and recorded on the record medium and determining whether all the plurality of pieces of data can be reproduced according to the group name contained in the management information file when the plurality of pieces of data are reproduced as the result of the edit.

12. A program that causes a computer to execute a process, the computer controlling an information process apparatus that processes a plurality of pieces of data recorded on a record medium, the process comprising the steps of:
identifying encoding systems for the plurality of pieces of data in an edit for which they are connected and successively reproduced;
generating one management information file that manages the result of the edit so that the management information file contains a group name to which all the encoding systems identified at the identification step belong and recording the management information file in a directory of the record medium attachable and detachable to and from the information process apparatus, the directory for the management information file being different from other directories of the record medium; and
reading the management information file generated at the generation step and recorded on the record medium and determining whether all the plurality of pieces of data can be reproduced according to the group name contained in the management information file when the plurality of pieces of data are reproduced as the result of the edit.
